(19) United States
(12) Patent Application Publication
(10) Pub. No.: US 2007/0154876 A1
(43) Pub. Date: Jul. 5, 2007

(54) Learning system, method and device

(76) Inventor: Shelton E. Harrison JR., Culver City, CA (US)

Correspondence Address: SHELTON E. HARRISON, JR., 6225 CANTERBURY DRIVE., UNIT 105, CULVER CITY, CA, 90230, US

(21) Appl. No.: 11/648,940

(22) Filed: Jan. 3, 2007

Related U.S. Application Data
(60) Provisional application No. 60/755,930, filed on Jan. 3, 2006.

(51) Int. Cl. G09B 25/00

(52) U.S. Cl. 434/365

(57) ABSTRACT

A study aid apparatus provides an academic outline that is arranged three dimensionally through the use of a number of moving parts. Several modules, each devoted to a separate category, are attached to the face of a base member so that the several different category headings can be seen simultaneously. Parts within a given module are manipulated to reveal subheadings, sub-subheadings, and so on. In this way, the invention provides study materials that mimic the workings of the human mind more accurately than do prior study materials, thereby enhancing a student's learning experience and increasing the likelihood of effective recall. In particular, the invention keeps information “in perspective,” such that major concepts remain prominent at all times whereas minor details are suppressed until needed.

### CROSS-REFERENCE TO RELATED APPLICATIONS

Priority filing of U.S. provisional patent application 60/755,930, filing date Jan. 3, 2006, entitled “Sequential Representation System, Method and Device,” is claimed. Said provisional patent application is hereby incorporated by reference in its entirety into the present disclosure.

A portion of the disclosure of this patent document contains material which is subject to copyright protection. The copyright owner has no objection to the facsimile reproduction by anyone of the patent documents or patent disclosure, as it appears in the patent and trademark office patent file or records, but otherwise reserves all rights whatsoever.

### STATEMENT REGARDING FEDERALLY SPONSORED RESEARCH AND DEVELOPMENT

None.

### REFERENCE TO SEQUENCE LISTING, A TABLE OR A COMPUTER PROGRAM LISTING APPENDIX

None.

### BACKGROUND OF THE INVENTION

1. Field of the Invention

The invention relates to study aids and electronic books.

2. Description of the Related Art

Under the related art, outlines used for study in preparation for standardized tests, such as the bar exam, proceed sequentially such that a major heading is followed by minor points which are in turn followed by another major heading, and so on. Such an approach is not ideal in that the human mind does not function or learn in a sequential fashion. Instead, the human mind appears to store information as a web of related concepts, and, in retrieving a particular piece of information, the mind goes directly to the relevant portion of this web. What is needed, therefore, is a study mechanism that more accurately reflects the workings of the human mind while still embodying the academic rigor and comprehensive organization of a conventional outline.

Electronic book devices (“EBD”) are known, including EBDs that use a single display, a hinged display, or a rollable “electronic ink” or “electronic paper” display. See, e.g., information disclosure statement. However, EBDs under the related art have generally enjoyed very little consumer acceptance and have certainly done little to replace conventional print books. The reasons for lack of acceptance of EBDs under the related art are numerous. First, users are simply accustomed to the way books have been for centuries and prefer the familiar look and feel of a print book. Second, print books do not require a power source, bootup time, and all the other maintenance associated with EBDs under the related art. Third, unlike EBDs, print books can be read even when highly damaged. Fourth, EBDs under the related art have variable content, whereas print books do not change from day to day, and readers actually appear to prefer the permanent nature of a print book. Fifth, there is a major social element to a print book that is lost in an EBD under the related art: a print book has a spine that indicates exactly what the content is (Romeo and Juliet, for instance), and such a book can be rested on a bookshelf, a coffee table, or carried to a restaurant as a conversation piece. In other words, a print book serves as an external indication to the world regarding what the book's owner reads and considers important. Since EBDs under the related art do not contain fixed content nor a permanent spine nor a front or back cover that clearly indicates the content included therein, EBDs under the related art are unable to serve the social role of conventional book ownership. Moreover, they fail to allow customization—such as book-signing by an author—since such customization would be worthless or misleading once the contents of a given EBD under the related art have been changed.

Many of these reasons run contrary to conventional thinking in high technology fields. Specifically, under conventional thinking, more is better: faster processors, greater amounts of data memory, increased online access, increased user control of content, etc.—all of these things that speak of technological “progress” are almost uniformly considered to be desirable by inventors, technologists and product developers. But in the case of books, electronic books have failed to make significant inroads—even among the technologically savvy—because they fail to serve many of the heretofore unrecognized purposes that conventional print books serve.

What is needed, therefore, is an electronic book device that readers of books will actually use because it serves these other purposes as well as a print book does or better. In particular, what is needed is an electronic book that can still serve the social role of conventional print book ownership, by, inter alia, having fixed content and a spine-like side that indicates this fixed content.

EBDs under the related art fall short in other ways also. Variable content requires users, who already constantly have to learn how to use new cell phones and other electronic devices, to learn how to manage yet another technology, to navigate to a web site and download a new book, etc. What is needed, therefore, is an electronic book that requires no effort out of users, one that requires no significant maintenance or is self-maintaining.

Electronic books under the related art, since they are designed to be all things to all people and carry huge quantities of content, have heretofore needed no special bookshelf. Under the related art, a user simply downloads all desired documents into a single EBD for viewing and deletes them when no longer needed. This approach, however, has not met with commercial success for the reasons described above. But, in order to enable the remainder of the present invention and thereby meet the goals described herein, a new form of physical bookshelf is required.

Integration of electronic books with conventional books on a physical bookshelf also requires a better way to manage physical books, particularly looseleaf binders, so that they stay in a more suitable physical arrangement than under the related art. What is needed, therefore, is a physical, electronic bookshelf that serves as an integrated communication and recharging docking station for a plurality of EBDs and which is designed in such a way as to give the appearance of a conventional bookshelf, thereby facilitating service of the conventional roles of a print book while also serving to hold both electronic and print books in a desirable arrangement.

EBDs under the related art, however, are not designed to interact with such a physical electronic bookshelf as disclosed herein. In particular, EBDs under the related art are not shaped so as to simultaneously (i) expose a “spine”-like member that indicates the content of the EBD and (ii) hide from view, for aesthetic reasons, a mechanism whereby the EBD can dock to a disclosed electronic bookshelf. What is needed, therefore, is an EBD that is shaped to simultaneously serve both the conventional aesthetic role played by a print book when resting on a bookshelf and the electronic role of an EBD that is communicatively coupled to an electronic bookshelf, without having the electronic role interfere with the aesthetic role or vice versa.

EBDs under the related art, since they are not designed to accommodate an electronic bookshelf, do not provide a system whereby a particular EBD can be found easily on a shelf. This situation is not ideal in that sometimes a single EBD may not be easy to find among a plurality of books. What is needed, therefore, is an EBD and electronic bookshelf that assist users in easily finding a desired book device.

An EBD under the related art also requires a user to begin using the device (i.e., look in the display) in order to find out what the current contents of the device are. Such a situation is not ideal, because users of conventional books are accustomed to being able to tell what is in a book from across the room, namely, by reading the spine of the book. But when content is variable, such ease-of-use is impossible under the related art. What is needed, therefore, is a mechanism whereby an electronic book can have a permanently printed or an automatically updating “spine” that can be read from across the room and requires no interaction or navigation by a user.

EBDs under the related art, in failing to provide dedicated-content devices that prevent user modification of content, thereby also fail to enable an automatic-update system that is specifically designed for such a novel context, i.e., remote update by a publisher, manufacturer or party who controls a particular URL but not by the user. They also fail to provide an easy way to manage digital rights, since a single EBD under the related art is designed to handle many files from many different publishers. What is needed, therefore, is a dedicated-content EBD that simultaneously prevents user modification of content while enabling automatic updating of such content and while also enabling handling of digital rights by dedicating a reading device to a single publisher's single publication such that the device is prevented from any modifications except those downl from a particularly identified URL and authenticating this device before any such updating of content.

In failing to provide automatic-updating, dedicated-content EBDs, the related art also fails to provide a mechanism for displaying indicia that indicate the update cycle of a particular automatically updating EBD. What is needed, therefore, is a dedicated-content, automatic-updating EBD that provides such indicia.

In failing to serve the basic visual communication functionality served by conventional print book, more advanced visual functions are also unavailable under the related art. For instance, a user of a conventional print book sends a very different message to visitors of, his home or office by displaying old, embossed, leather-bound books as opposed to new paperback books. Such nuanced variations in the message that a user can send through book display are clearly unavailable under the related art. What is needed, therefore, is a mechanism whereby the different materials, printing processes, and binding processes used in conventional book-binding and manufacture can be used advantageously in conjunction with an EBD such that the ambient communication role played in conventional book display can be served by an EBD.

In failing to enable automatic-updating, dedicated-content EBDs with “spines” suitable for serving the communication role of a spine of a conventional print book, the related art further fails to enable a method whereby a suite of such EBDs, in which suite each separate device is dedicated to a discrete body of literature, can be provided. Yet many professionals are accustomed to and prefer to use reference materials that present discrete areas of a field in discrete packages. Indeed, it is useful for a lawyer, for instance, to be able to look at case law in one book and statutes in another book. What is needed, therefore, is a method of providing a predetermined collection or suite of dedicated-content EBDs in which the content of each such device is dedicated to a different area, source or authority within a field yet together form a comprehensive whole.

In failing to provide an electronic bookshelf device, the related art also fails to provide an electronic bookshelf device that is solar-powered. Yet the benefits of solar power are known. What is needed, therefore, is a solar-powered electronic bookshelf device.

Readers of conventional books are accustomed to reading the pages of books in the form of a “spread”, which term is used in the publishing industry to denote two facing pages. But an EBD comprising two monitors under the related art cannot mimic the appearance of a conventional book, because it does not provide a unitary spine and because conventional print books do not have hinges. What is needed, therefore, is a mechanism whereby a compound pair of housings for two displays can nonetheless appear to be a single conventional book.

Buttons and similar electronic interfaces detract from the user experience for users who are accustomed to reading print books. What is needed, therefore, is a more intuitive interface for turning the pages of a document being displayed by an EBD.

In failing to provide an electronic “spine”, the related art also fails to provide a mechanism for determining which content is displayed by such a spine. What is needed, therefore, is a mechanism for designating certain content as the appropriate content to be displayed by an electronic “spine”.

Print-on-demand technology for conventional print books is known, but since electronic book devices under the related art do not enable and have not attempted to enable dedicated-content EBDs with what the present disclosure calls “pseudo-spines”, the related art does not provide any form of “burn-and-print-on-demand” EBD. What is needed, therefore, is a burn-and-print-on-demand method for manufacturing dedicated-content EBDs with pseudo-spines as disclosed in the present invention.

Under the related art, there is no mechanism for displaying content so that the parts of an argument (premises, conclusion, etc.) are displayed in different colors or font types. But such a mechanism would be very useful for training people for the LSAT and other settings in which argumentation is used. Similarly, EBDs under the related art do not provide any means for displaying the parts of a sentence or parts of speech in different fonts or colors, or for having a pop-up, touch-sensitive dictionary function. What is needed, therefore, is a mechanism whereby such functions can be provided.

Under the related art, a “cuckoo” clock or a chime clock makes a sound at the top of every hour, but this sound is not instantly recognizable as a particular hour; rather, one must count the number of chimes to find out what hour is being sounded. Moreover, such a conventional sounding-clock does not serve an educational value. What is needed, therefore, is a clock that produces a sound at the top of every hour that instantly indicates the unique hour of the day that is current and also serves to educate a listener regarding musical intervals.

Under the related art, elevation of a broken or sprained limb requires that the limb be suspended from an external device or from another portion of the user's body, both of which approaches cause discomfort and immobility. What is needed, therefore, is a method of suspending a limb without tying the limb to an external structure or to another body part.

Under the related art, unintended gum damage may result from pressure and vibration caused by drilling to fill a cavity of a tooth. What is needed therefore is a method of defending against such damage.

Under the related art, patio furnishings (“welcome” mat, chairs, plants, statuettes, etc.) are often stolen, but permanently installing such furnishings is prohibitively time-consuming and costly relative to the value of the furnishings. What is needed, therefore, is an easy and inexpensive method of preventing such theft.

Under the related art, EBD users who wish to meet in person must arrange for themselves a time and place to meet. This situation is less than ideal in that it is time-consuming. What is needed, therefore, is an automatic method for setting up meetings at mutually desirable times and locations.

Under the related art, house pets can sometimes escape from a house when the owner temporarily opens the front door to receive a package or a guest. What is needed, therefore, is a method of protecting against such escapes.

Under the related art, an individual rubber stamp must be created for each given purpose, and the adjustability of such stamps is very limited (e.g., changing of a date or time). What is needed, therefore, is a single rubber stamp device that can be altered infinitely and easily.

Under the related art, smoke alarms serve to alert people who are in danger as well as those whose job it is to respond to such emergencies. However, such alarms do not serve the purpose of providing a direct, immediate, oral communication channel from the latter to the former. What is needed, therefore, is a method of using smoke alarms as temporary communication conduits during fire emergencies.

### BRIEF SUMMARY OF THE INVENTION

Invention provides a study aid apparatus that provides an academic outline that is arranged three dimensionally through the use of a number of moving parts. Several modules, each devoted to a separate category, are attached to the face of a base member so that the several different category headings can be seen simultaneously. Parts within a given module are manipulated to reveal subheadings, sub-subheadings, and so on. In this way, the invention provides study materials that mimic the workings of the human mind more accurately than do prior study materials, thereby enhancing a student's learning experience and increasing the likelihood of effective recall. In particular, the invention keeps information “in perspective,” such that major concepts remain prominent at all times whereas minor details are suppressed until needed. The invention also provides an electronic book device (EBD) that is dedicated to a single document and cannot be altered by the user but can be updated by a remote computer under the control of the publisher or manufacturer of the EBD or the document. The EBD further includes a “pseudo-spine” so that it appears to be a conventional print book and thereby serves the many non-reading purposes served by print books, such as that of “conversation starter”. A particular embodiment of the EBD provides an electronic pseudospine and markup language technique that is particularly suited for a disclosed “burn-on-demand” sales model. A new bookshelf designed for use with the new EBD is also disclosed, allowing for automatic updating, battery charging, querying and easy locating of EBDs. A new attachment mechanism, adaptable for use with an EBD or with a looseleaf binder, allows reading materials to “snap” into place on a bookshelf or in a carrying case and thereafter remain fixed in place until “snapped” out again. A new clock chime function tells the hour by simply sounding a musical interval that is assigned to the current hour of the day in a disclosed hour-to-interval matrix. A disclosed cover cradles an EBD, further enhancing its resemblance to a print book, while also serving as an intermediate docking station for docking an EBD to an electronic bookshelf. A disclosed, automatically updating newspaper version of the EBD eliminates the need for traditional print newspapers. A new collection of EBDs serves the role of a traditional legal library. A new page-turning mechanism allows page-turning by simply tilting the EBD. A disclosed window-mounted bookshelf charges EBDs using solar power. A disclosed meeting-arrangement system allows EBD users to arrange meetings easier. A disclosed display technique and multiple disclosed markup languages assist using EBDs as study tools by displaying parts of an argument or parts of speech in different ways. A dental technique protects EBD users from dangers associated with tooth drilling by anchoring a target tooth to neighboring teeth and coating neighboring surfaces with a compound. A disclosed smoke detector protects EBD users by allowing emergency responders to communicate orally through the smoke detector unit itself. A disclosed process allows for EBD recommendations based on personality, and an EBD sales model by telephone is also disclosed. A disclosed door attachment keeps house pets from escaping by obstructing their path. A disclosed rubber stamp is infinitely configurable by transmission of a “pin map” from computer to stamp.

### BRIEF DESCRIPTION OF THE DRAWINGS

FIGS. 1A and 1B disclose perspective views of a disclosed EBD.

FIGS. 2 through 4 disclose perspective views of a disclosed electronic bookshelf.

FIG. 5 discloses a schematic overview of a disclosed EBD and electronic bookshelf system.

FIG. 6A discloses a perspective view of an alternative EBD according to the present invention.

FIG. 6B discloses an hour-to-interval matrix according to the present invention.

FIGS. 7 through 8B, FIG. 13A, and FIGS. 23C through 23D disclose perspective views of EBD covers according to the present invention.

FIG. 9 discloses a schematic overview of disclosed EBD system component alternatives.

FIGS. 10A through 10C and FIGS. 23A through 23B disclose perspective views of alternative EBDs according to the present invention.

FIG. 11 discloses an example of a disclosed predetermined collection of EBDs according to the present invention.

FIG. 12 depicts the steps of a disclosed process of creating and using an EBD according to the present invention.

FIG. 13B depicts an EBD in use with a disclosed outline apparatus.

FIGS. 14 through 16 depict perspective views of a disclosed solar-powered electronic bookshelf according to the present invention.

FIG. 17A through 20 depict perspective views of a disclosed mechanism whereby an EBD, cover, or notebook can be fixed in place on a bookshelf.

FIGS. 21A and 21B depict the related art from a bird's eye view, demonstrating a problem that is solved by the present invention.

FIGS. 22A and 22B depict a carrying case for use with the mechanism depicted in FIGS. 17A through 20.

FIG. 23E depicts the steps of a disclosed process whereby a user turns a page by tilting an EBD.

FIG. 23F and FIG. 25A depict the steps of disclosed processes whereby a user purchases an EBD according to the present invention.

FIG. 24 depicts an excerpt from a document that includes marked-up text for display through an electronic pseudo-spine according to the present invention.

FIG. 25B discloses examples of relationships between prices and telephone numbers used in the process depicted in FIG. 25A.

FIGS. 26 through 29 depict alternative disclosed methods of displaying the text of a document according to the present invention.

FIG. 30 depicts an excerpt from an outline under the related art, demonstrating a problem that the present invention solves.

FIGS. 31 through 37 depict a disclosed study aid device and parts thereof.

FIG. 38 depicts the steps of a disclosed process whereby the disclosed study aid device is created and used.

FIGS. 39 through 43 depict a disclosed limb suspension device according to the present invention.

FIGS. 44 through 46 depict perspective views of a patient's mouth and a disclosed system of protecting against gum damage while drilling.

FIG. 48 depicts the steps of a disclosed process whereby damage from drilling is minimized.

FIGS. 49 and 50 depict a disclosed system for preventing theft of patio furnishings.

FIG. 51 depicts the steps of a disclosed process whereby patio furnishing theft is prevented.

FIG. 52 depicts the steps of a disclosed process whereby meeting times and places are automatically arranged according to the present invention.

FIG. 53 depicts a disclosed Web submission form for use in the above process for arranging meetings.

FIGS. 54A and 54B depict a disclosed pet-escape prevention device.

FIGS. 55A and 55B depict perspective views of a disclosed, universal, infinitely adjustable rubber stamp according to the present invention.

FIG. 55C depicts the steps of a disclosed process whereby an infinitely adjustable rubber stamp is created and used.

FIG. 56 depicts a disclosed smoke alarm equipped with a disclosed smoke-gate function according to the present invention.

FIG. 57 depicts the steps of a disclosed process whereby a smoke-gate-equipped smoke alarm functions.

### DETAILED DESCRIPTION OF THE INVENTION WITH REFERENCE TO THE DRAWINGS

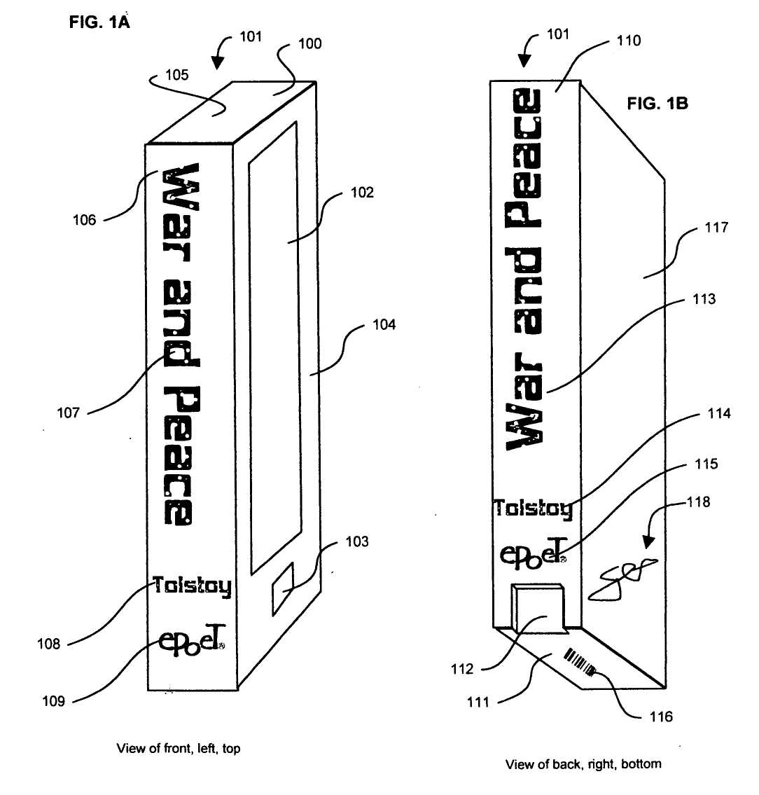

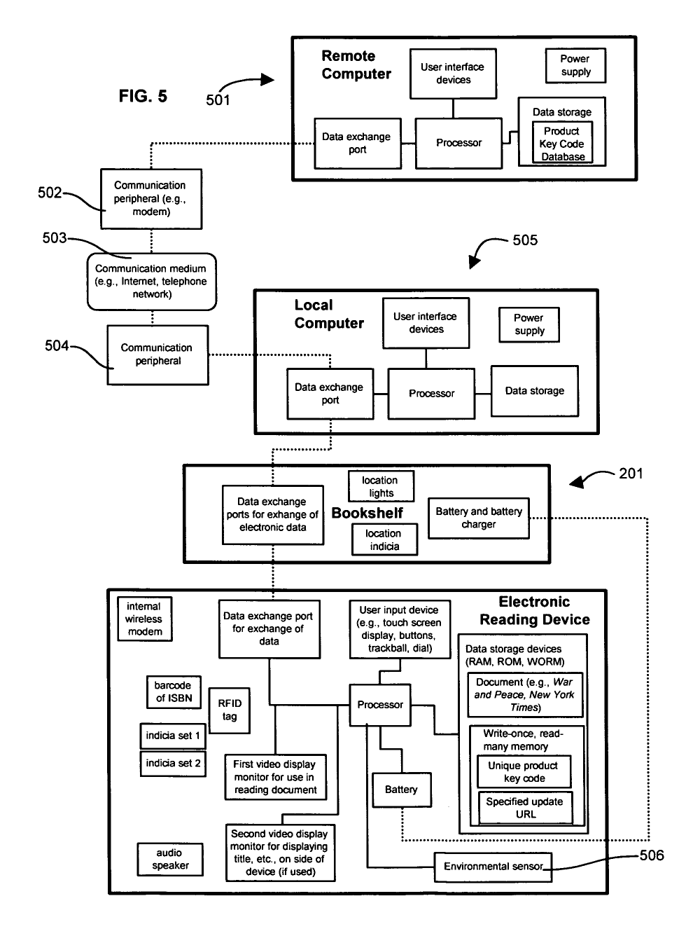

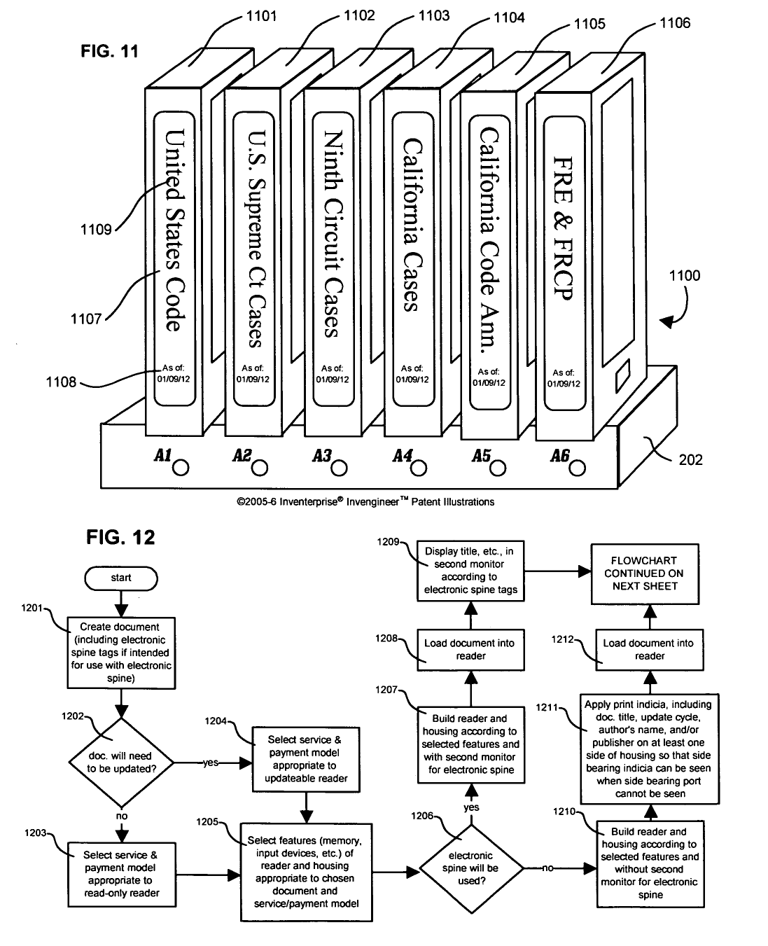

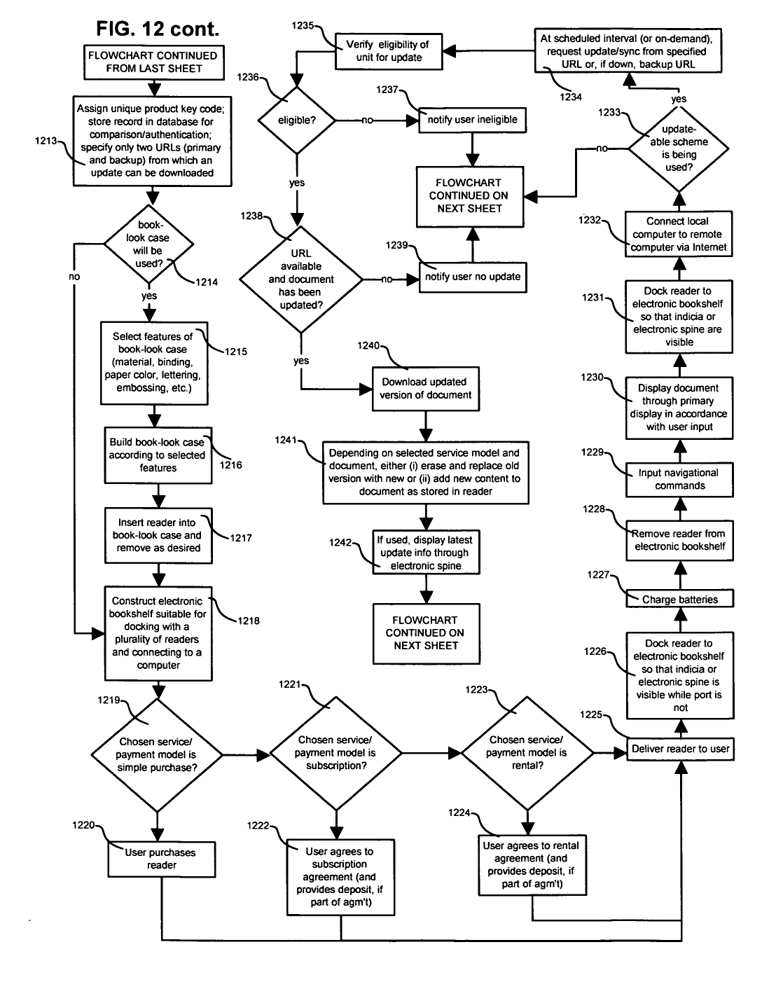

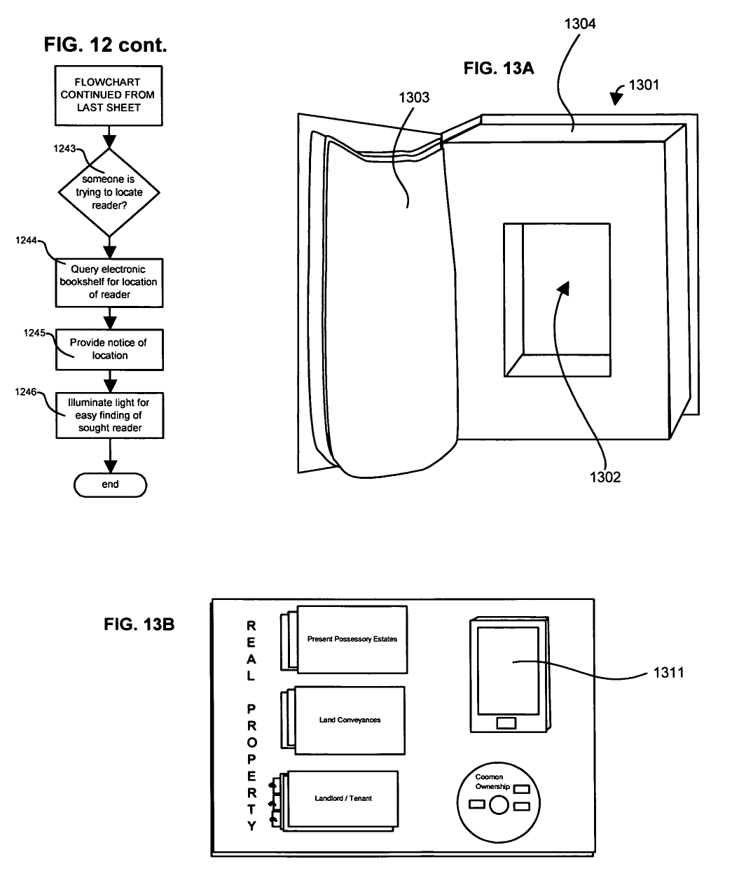

Turning to FIGS. 1A and 1B, an EBD 101 according to the present invention comprises a monitor 102, manual interface 103 for inputting navigational commands such as turning a page (which interface can be one of any from the sample interfaces depicted in FIG. 9, or a similar interface), a port 112 for docking to a disclosed docking station called an “electronic bookshelf” for the purposes of recharging the battery (see FIG. 5) of the device 101 and exchanging electronic information with other devices (see FIG. 5), and a plastic housing 100 for the aforementioned components, said housing 100 having multiple sides, including a front 104 and back 117, a left side 106 and a right side 110, and a top 105 and a bottom 111. These sides may be described as “generally rectangular plane segments” or as “polygonal surfaces” or otherwise for the purposes of generality. Inside the EBD (which may also be called a “reading device”) are components depicted in FIG. 5, such as a data processor, a battery, and a disclosed combination of electronic memory mechanisms which are configured to “dedicate” the EBD to a single document (see FIG. 12) yet allow updating of this document.

Affixed to the left side 106 are indicia 107-109 indicating at least one title 107, said title being the title of a document stored in memory (see FIG. 5) of the device 101. These indicia 107-109 are affixed to the left side 106 in a manner that is intended to be permanent, e.g., printed, embossed, debossed, or otherwise affixed to the left side 106 using conventional methods for printing on plastic or other material. Since this side 106 includes indicia of a title 107, author of a document 108, and publisher logo 109, and otherwise appears similar to a spine of a conventional print book, such a side is called in the present disclosure a “pseudo-spine”. A pseudo-spine is used to communicate information visually regarding the contents of an EBD according to the present invention.

Another set of indicia 113-115 indicating the title 113, the author 114 and the publisher 115 of the document are affixed to the right side 110. However, since the right side 110 further comprises the port 112 and therefore differs from the appearance of a conventional print book spine, the right side 110 is considered a “secondary pseudo-spine”. The signature 118 of the author who wrote the document appears on the back 117 of the device, and a barcode 116 appears on the bottom 111.

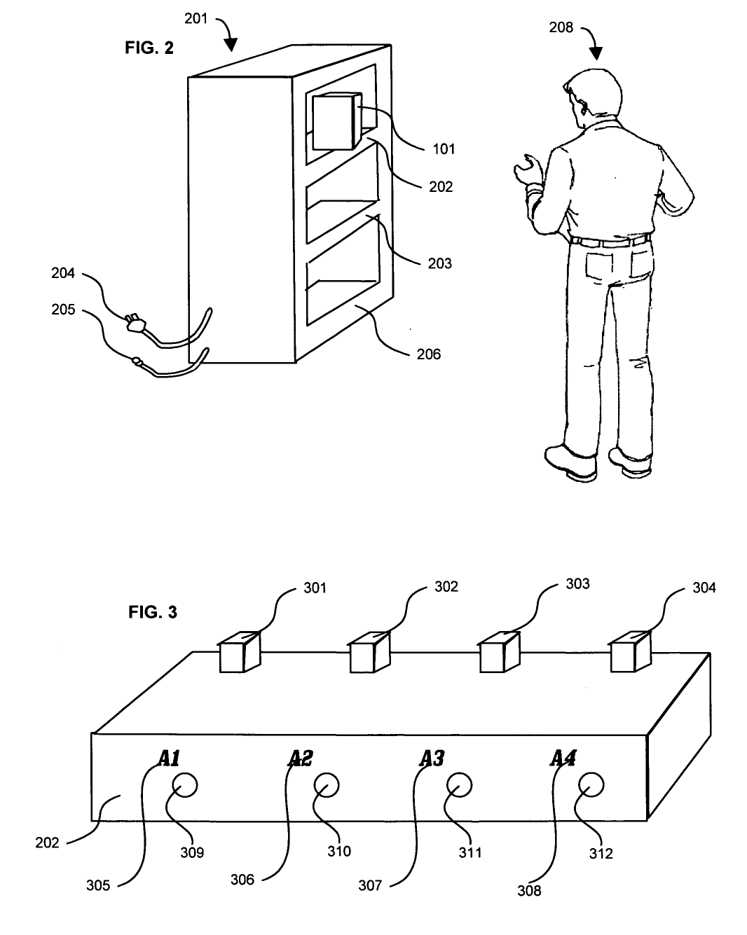

FIG. 2 depicts an electronic bookshelf 201, with the EBD 101 docked on a top shelf 202. Additional shelves 203 and 206 are also provided, as is a power cord 204 to be plugged into an electrical outlet (not depicted) and an interface cable 205 for connecting to a local computer (505 in FIG. 5). When a user 208 views the bookshelf 201 he can see the pseudo-spine of the EBD 101 and thereby see what the content of the EBD is.

FIG. 3 depicts a close-up view of a portion of the top shelf 202 of the bookshelf 201. This shelf 202 provides a plurality of contact points 301-304 for connecting to the port 112 of the EBD. Also included are indicia 305-308 of location, one identifier per contact point. Also included are finder lights 309-312 to assist in finding a particular location. Thus, when someone is seeking an EBD 101 that is docked on the shelf 202 as shown in FIG. 2, all contact points 301-304 are queried by local computer (505 in FIG. 5) for the location of the sought EBD, the indicia corresponding to the book's location are communicated to the user, and the light at that location illuminated so that the seeker can easily find that location.

The electronic bookshelf system can therefore be generally described as follows:

A bookshelf comprising a first shelf, said first shelf further comprising a plurality of book contact points, including a first book contact point and a second book contact point and at least one external device contact point. A first electronic book device according to the present invention and a second electronic book are inserted into said first shelf so that a port of said first electronic book comes into contact with said first book contact point and a port of said second electronic book comes into contact with said second book contact point. Said bookshelf additionally comprises a second shelf, said second shelf being positioned below said first shelf and further comprising a plurality of book contact points. Said at least one external device contact point is connected to an external device, such as a computer, so that said first electronic book and said second electronic book can be electronically accessed and automatically updated through said computer. The electronic bookshelf is used as follows: a first version of a first document is loaded into the memory of said first electronic book. A first version of a second document is loaded into the memory of said second electronic book. Said first electronic book and said second electronic book are placed on said first shelf of said bookshelf. When a user wishes to read said first document, he or she removes said first electronic book from said electronic bookshelf and transports said first electronic book to a location where the user wishes to read. When he or she has finished reading said first document, the user replaces said first electronic book on said electronic bookshelf.

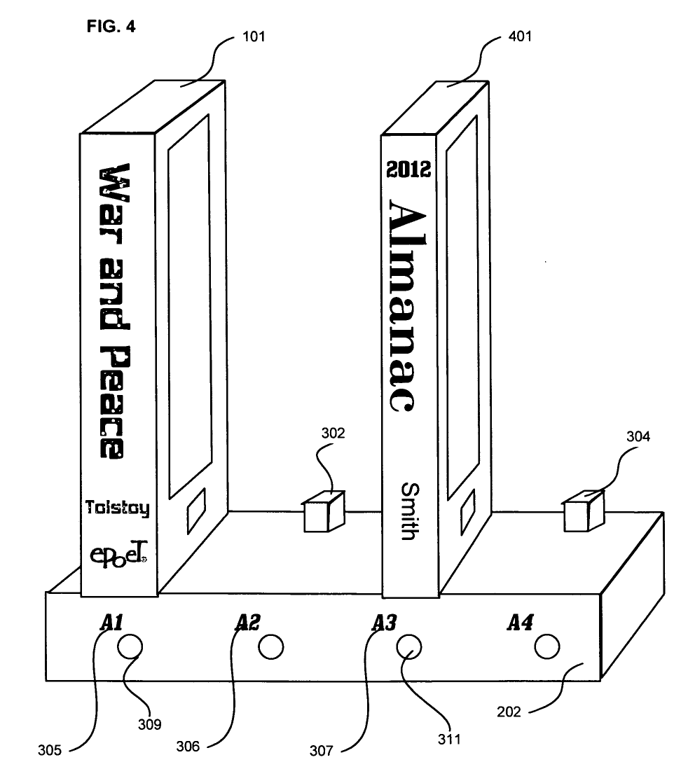

An example is depicted in FIG. 4, where one EBD 101 is located at a first location, which is labeled with a first indicium 305 (“A1”), while another EBD 401 is located at a second location which is labeled with a second indicium 307 (“A3”). Thus, in the depicted example, if a seeker were seeking for War and Peace, the EBD 101 at location “A1” 305, the light 309 at location “A1” 305 would be illuminated. Through the system depicted in FIG. 5, the electronic bookshelf 201 may also be queried for a reading device by a remote computer 501 connected to a local computer 505 via Internet 503. This may be useful for one book owner to network with another book owner so that they can know what is in each other's collection.

Thus, the EBD according to the present invention may be described as: an electronic system comprising: a first display monitor suitable for displaying a first page of a first document, said first document being stored electronically in a first electronic memory mechanism; said first electronic memory mechanism, said first electronic memory mechanism be modifiable; a first update location, said update location being stored in a second electronic memory mechanism; said second electronic memory mechanism, said second electronic memory mechanism being read-only once said update location has been specified; a polygonal housing, said housing comprising at least a first side, a second side, and a third side wherein said first side and said third side are substantially opposite from each other and: said first side further comprises a first set of indicia, said first set of indicia indicating at least a first title, a first author, or a first publisher of said first document; said second side comprises said first display monitor; and said third side further comprises a first port, said first port being suitable for use in conveying data or recharging a first battery; and wherein: said housing is configured, constructed or shaped such that said first side may be viewed directly from a first perspective while said first port remains hidden from view of said first perspective and such that said first port may be viewed directly from a second perspective while said first side remains hidden from view when said first port is observed from said second perspective. The system described in the preceding sentence may also comprise an electronic bookshelf, said bookshelf being configured to connect to said first port and to support the weight of said housing such that, when said electronic bookshelf is connected to said first port, said first side is visibly exposed while said third side is hidden from view. The system described in this paragraph may also be described as storing said first document and said first electronic memory mechanism in such a way as to prevent user modification or deletion of said document but allow updating or replacing of said document via a predetermined authentication and synchronization process, whereby said electronic memory mechanism is updated with a newer version of said first document by requesting and downloading said newer version from a remote computer only at a specified URL through a local computer that is communicatively connected to the electronic bookshelf and the Internet.

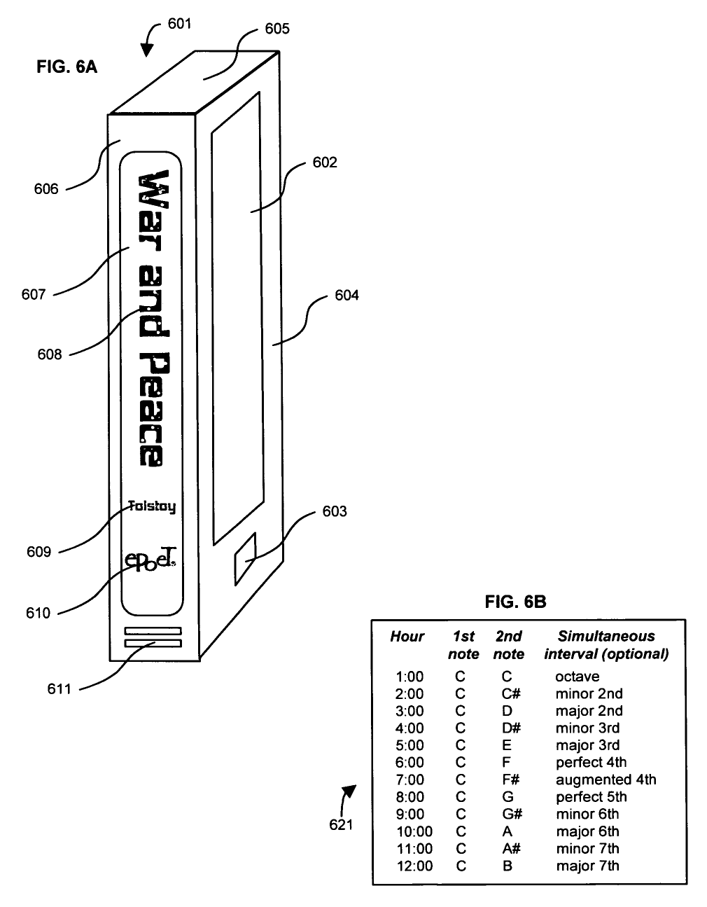

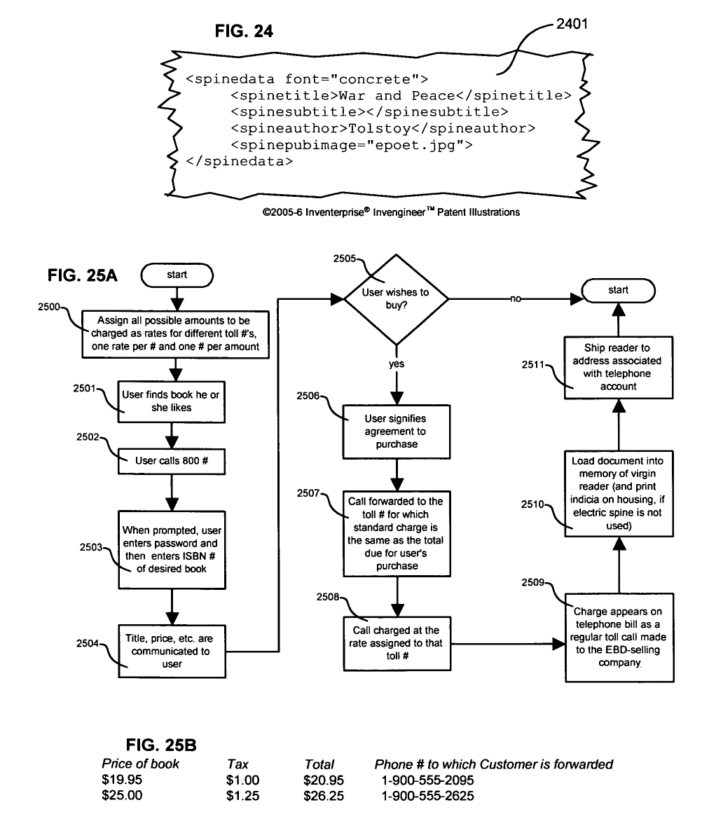

An alternative EBD 601 is depicted in FIG. 6A. This device 601, like the device 101 depicted in FIG. 1A, has a top 605, a front 604 and a left side 606. The front 604 includes a monitor 602 for displaying the pages of a document and includes a manual interface 603. But this device 601 differs from the earlier depicted device 101 in that the left side 606 serves as a pseudo-spine by function of a second electronic monitor 607 that is included in this side 606. The second monitor 607 displays the title 608, the author's name 609, and a logo 610 of the publisher of the document. Instructions for what to display in the second monitor are included in the document through the use of some marked-up text 2401 such as that depicted in FIG. 24. Through the use of an electronic pseudo-spine 606 rather than a print pseudo-spine 106, a manufacturer need but load an appropriately tagged document into the memory of a virgin EBD and the title, etc., of that document will be automatically displayed electronically through the second monitor 607. By eliminating the printing step, such flexibility facilitates “burn-on-demand” EBDs that provide dedicated-content: units are manufactured without content and the document to which a given unit will be dedicated is only loaded into the unit in response to customer demand for that document, but, since the electronic pseudo-spine simply displays what is described as spine data in the software document, no further physical manufacturing steps are required to dedicate the unit to the document. This is not the case using a print pseudo-spine, because once such an EBD is dedicated to a particular document, the indicia indicating what that document is must be physically printed onto the housing, which adds delay and expense. The steps of a “burn-on-demand” process are disclosed in FIG. 25A. The second display 607 is particularly apt as an application for so-called electronic paper that does not, after displaying certain content, require the input of any additional electricity except to change that content, since the content of this monitor is not intended to change often, if at all.

The EBD 601 also comprises an audio speaker 611 for use in a disclosed aural time notification system. In particular, the device 601 is configured to sound at the top of each hour either (I) two notes sequentially or (II) two notes simultaneously according to a disclosed hour-to-interval matrix 621 shown in FIG. 6B. Thus, as per the hour-to-interval matrix 621, at the top of the one o'clock hour, the device 601 sounds an octave. At the top of the two o'clock hour, the device 601 sounds a minor second (halfstep). At the top of the three o'clock hour, the device 601 sounds a major second (whole step). At the top of the four o'clock hour, the device sounds a minor third (spanning three halfsteps), etc. In this way, a person who knows musical intervals can immediately tell what time it is when the clock sounds. Meanwhile, it serves as an educational device for learning musical intervals without a great deal of effort.

The audio time notification system disclosed herein may therefore be described generally as follows: a method for conveying the current hour of the day, said method comprising the following step: sounding a first aural notice, said first aural notice being selected from the group consisting of (I) two musical notes played simultaneously and (II) two musical notes played consecutively, wherein: said two musical notes together form a first interval, said first interval being assigned to the current hour of the day according to an hour-to-interval matrix, said hour-to-interval matrix comprising a plurality of relationships between hours and intervals such that no interval is assigned to more than one hour.

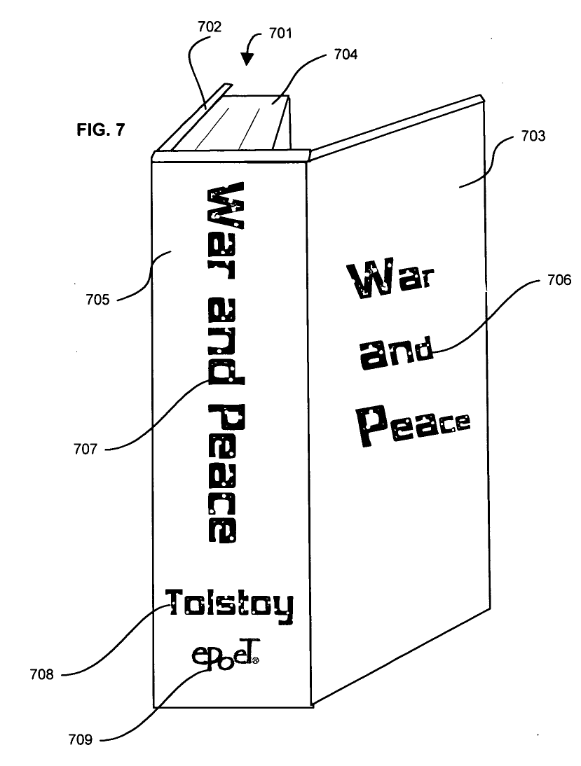

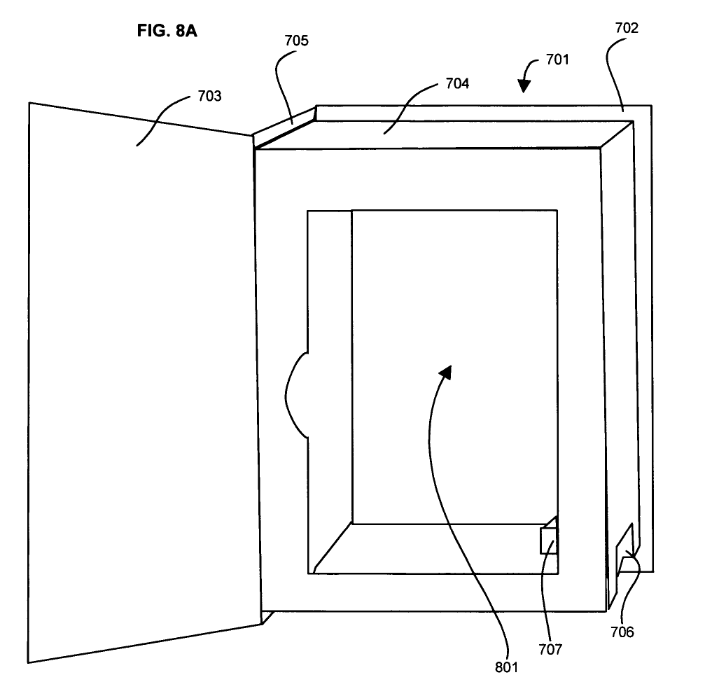

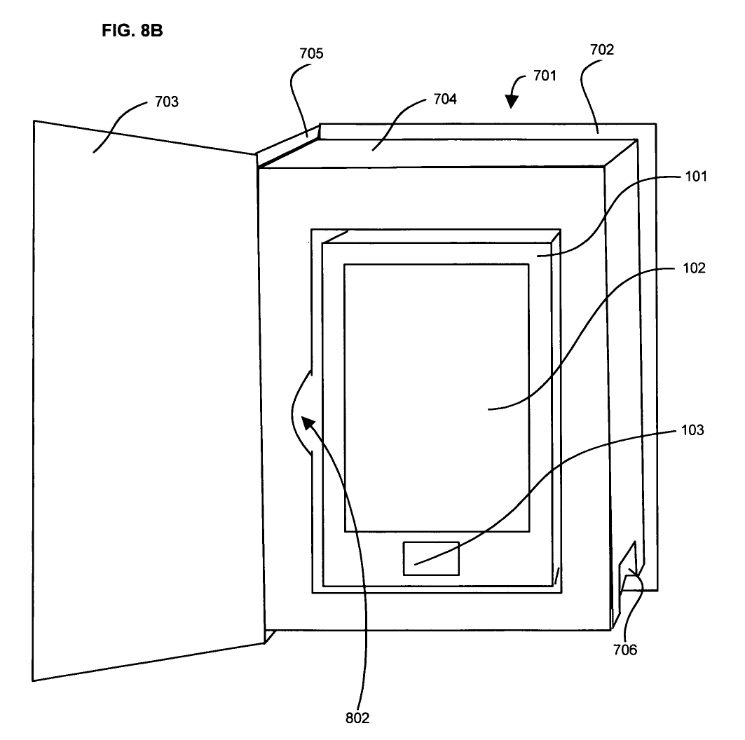

A “book-look” EBD cover 701 is disclosed in FIG. 7. This cover 701 is constructed to appear to be a conventional print book but actually to be a cover for an EBD according to the present invention. Thus this cover 701 includes a cradle 704, a back member 702 resembling the back cover of a hardback book , a front member 703, and a side member 705. The side member 705, which includes indicia for a title 707, an author 708, and a publisher 709, is designed to resemble the spine of a conventional print book, and the front member 703, which includes indicia for a title 706, is designed to resemble the front cover of a conventional print book. The cradle 704 provides a cavity 801 that is depicted in FIG. 8A, and the EBD 101 can be inserted into this cavity as depicted in FIG. 8B. An extra space 802 allows room for a user's finger to reach into the cavity so as to remove the EBD 101 when desired. This cover 701 also includes a port 706 suitable for docking to the electronic bookshelf contact point 301-304 and for conveying energy and information to the electronic device 101 stored in its cradle 704 by way of an internal contact point 707 configured to make contact with the port 112 of the EBD 101. This cover achieves the best of both worlds, having the appearance of a print book when docked on the electronic bookshelf yet fully accommodating the electronic features of the EBD system disclosed herein.

The EBD cover system disclosed herein may therefore be described generally as follows: a case for an electronic book device comprising: a housing, said housing comprising a first side, a second side, a third side, and a cradle; a first port suitable for docking to a docking station; and a second port suitable for docking to said electronic book device when said electronic book device is in said cradle, wherein: said first side comprises indicia of at least a title or an author of a first document, said first document being stored in the memory of said electronic book device; said second side is movably coupled so as to alternately cover or reveal said cradle; and said third side comprises said first port.

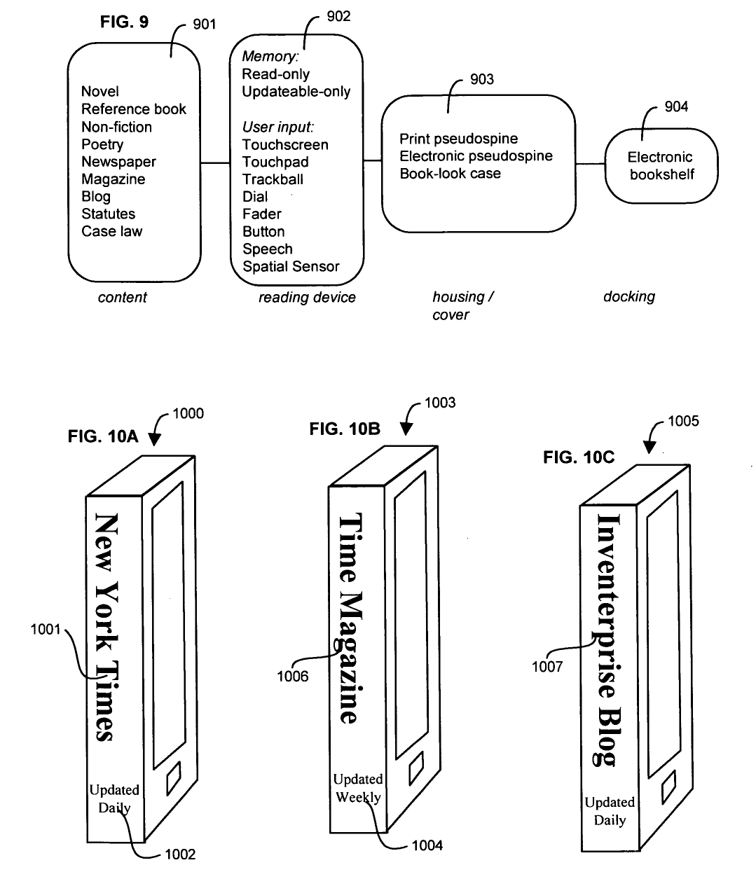

FIG. 9 depicts the present invention as an abstract system including content 901 such as the various example documents shown, a reading device 902, the housing or cover 903, and an electronic bookshelf 904. FIG. 10A discloses an EBD 1000 providing a pseudo-spine configured to display indicia of the title 1001 of a newspaper and indicia of an update cycle 1002. FIG. 10B discloses an EBD 1003 providing a pseudo-spine configured to display indicia of the title 1006 of a periodical with a different update cycle 1004. FIG. 10C discloses an EBD 1005 providing a pseudo-spine configured to display indicia of the title 1007 of a blog.

FIG. 11 discloses a specially configured collection 1100 of EBDs, all of which are docked on the electronic bookshelf 202 and which together comprise a uniquely useful and flexible legal library. The collection is configured such that each EBD is dedicated to a separate body of law: an EBD 1101 which contains the United States statutes; an EBD 1102 which contains US Supreme Court cases; an EBD 1103 that contains Ninth Circuit cases; an EBD 1104 that contains California cases; an EBD 1105 that contains California statutes; and an EBD 1106 that contains Federal Rules of Evidence and Federal Rules of Civil Procedure. Each EBD in the collection 1100 includes an electronic pseudo-spine, providing a monitor 1107 that displays the title 1109 of the document to which the reading device has been dedicated and displays an update indicator 1108 that lets a human viewer see at a glance whether the reading device contains the current version of the document to which it is dedicated. Automatic updating is made possible by docking the EBDs 1100 to the electronic bookshelf 202 that is connected (see FIG. 5) to a remote computer that contains the most recent version of the documents so as to download automatically this most recent version.

This collection may be generally described as: a plurality of EBDs; an electronic bookshelf configured to couple communicatively with said plurality of EBDs; wherein each EBD is devoted to a separate body of literature, each said separate body of literature being within the same academic or professional field, such as law, and wherein each EBD is configured (I) to display indicia of the body of literature to which it is dedicated and the time of its most recent update, said indicia appearing on a first side, said first side being visible when said plurality of EBDs is docked to said electronic bookshelf; (II) to display the contents of the body of literature to which it is dedicated through a display appearing on a second side which is substantially perpendicular to said first side; and (III) to couple with said bookshelf through a port appearing on a third side, said third side being substantially perpendicular to said second side and substantially parallel to said first side, such that said third side cannot be seen when a user is viewing said first side.

FIG. 12 discloses the steps of a process whereby the disclosed system is used. An electronic document is created 1201, including the text of the document (a novel, a particular day's newspaper, etc.) as well as marked-up electronic spine data as shown in FIG. 24. If the document is intended for updating 1202 (e.g., a newspaper), a service and payment model appropriate to using an updatable reading device is selected 1204. If the document is not intended for updating 1202 (e.g., a novel), a service and payment model appropriate to a read-only reading device is selected 1203. Physical features of the EBD are selected 1205 in accordance with the selected service and payment model. If an electronic pseudo-spine will be used 1206, an EBD including both a first monitor for displaying the document and a second monitor for displaying the electronic pseudo-spine data as shown in FIG. 6 is constructed 1207. The document is then loaded 1208 and the electronic pseudo-spine data displayed 1209. If an electronic pseudo-spine will not be used 1206, an EBD without an electronic pseudo-spine monitor is constructed 1210. Indicia pertaining to the document to which the given reading device will be dedicated are 1211 printed on the device, and the document is loaded 1212 into the reading device. A unique identification number/product key code is assigned 1213 to the reader for use in authentication steps discussed below. Additionally, if the EBD is to be updateable, a primary URL and a backup URL are specified 1213 as the only sources for updates of the content of the EBD, and such information is stored as read-only once it has been specified, such that the EBD unit cannot be repurposed thereafter. A new document version at one of these URLs can be downloaded so as to replace or update content of the EBD when it is more recent than the version stored in the EBD as described below.

If a “book-look” cover such as that depicted in FIG. 7 is to be used 1214, features of the cover (such as embossing) are selected 1215. This cover is then manufactured 1216 and the EBD inserted into and removed from the cover as desired 1217. The electronic bookshelf is then constructed 1218 so as to be suitable for docking to a plurality of readers and connecting communicatively to a local computer so as to enable electronic querying of the bookshelf contents and automatic downloading of updates from a remote computer. If the chosen service and payment model is simple purchase 1219, a user simply purchases 1220 the reading device. If subscription 1221 (which model is probably only appropriate for documents that are updated), user agrees 1222 to a subscription agreement and provides a deposit if required in the given service/payment model. If rental 1223, user agrees 1224 to a rental agreement. The reading device is then delivered to the user 1225 who is then free to dock the reading device to the electronic bookshelf so that the pseudo-spine is visible 1226. Docking also charges the batteries 1227. When the user wishes to read, he or she removes 1228 the reader from the electronic bookshelf. To turn pages, the reader inputs 1229 navigational commands through the selected interface. Which page is displayed 1230 is determined by the user input. The electronic bookshelf is connected to a local computer 1232, which is in turn connected to a remote computer via the Internet 1232. If an updatable service/payment scheme is being used 1233, the URL specified 1213 above is requested 1234 for an updated document, which is hosted on the remote computer. The querying unit is authenticated 1235 by transmitting the unique product ID key code to the remote computer, which compares this code to those authentic codes stored in a database of the remote computer. If eligible 1236, and there is an updated version available 1238 at the specified URL or backup URL, the newer version of the document is downloaded 1240 and this new version replaces or adds to 1241 the content already stored in the reading device. Note that the software in the EBD itself provides only the ability to ping the specified URL, which information is read-only after the unit has been dedicated, and if such URL (and the backup URL) is unavailable or there is no newer version there, the request is denied 1239. Attempts to get the EBD to request other documents or to modify the content of the EBD other than through synchronizing with the document at the specified URL should be blocked or simply redirected to the specified URL 1239. The time of this latest update is then displayed 1242 through the electronic pseudo-spine if used. Meanwhile, if the electronic bookshelf is one of many such bookshelves and a user wishes to find a particular reading device among the many shelves 1243, the electronic bookshelves are queried by computer 1244, the location of the desired EBDs provided 1245, and the light of that location is illuminated 1246 to make finding it easy.

The “book-look” cover can alternately be manufactured so that it has a plurality of paper pages 1303 that appear in front of the cradle 1304. These pages can be written on by the end-user so as to further customize the cover, as a gift item, for instance. These pages 1303 further enhance the resemblance of the cover 1301 to a print book, such that it can alternately be used as a way to give a surprise gift by hiding the surprise in the cavity 1302. Meanwhile, an EBD can be alternately used as shown in FIG. 13B to serve as one 1311 of the modules in a three-dimensional outline such as that discussed in greater detail below.

To summarize the material presented herein thus far, a user can interact with the disclosed EBD in a manner that is similar to the manner in which he or she interacts with a conventional print book, namely, the electronic book resembles a conventional book in that it has a title permanently affixed to its “spine” that indicates the content of the electronic book. This approach differs from the approach of the related art, in which the content of a given electronic book is not indicated in permanent printed form on the EBD itself. Moreover, electronic books under the related art are not dedicated to a single document, but rather provide user-alterable content. Note that the EBD according to the present invention provides no operating system whereby a user can change the content of the electronic book device other than to dock it in the electronic bookshelf so as to enable updating; rather, the device is constructed from both a hardware and software perspective such that no modifications to content can be made except, when applicable, that of downloading new content from the URL specified 1213 at the time the book was dedicated to a single documentary purpose. The only functions provided to users are those for navigating between the pages of the document, displaying definitions as shown below, and similar display-related controls. These steps of limiting user control —which approach runs directly contrary to conventional thinking —are a primary factor in making the present invention more attractive to users than the related art.

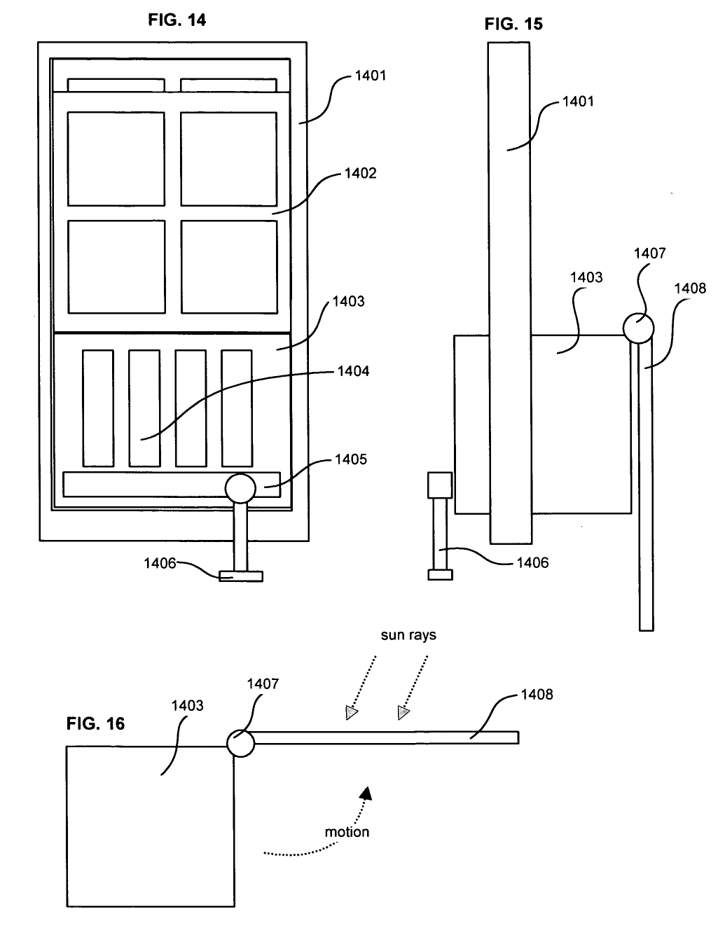

FIG. 14 depicts an electronic bookshelf 1405 that has been mounted in a window frame 1401 below a window pane 1402 in much the same way as an air conditioner may be so mounted. A group of EBDs 1404 are docked in the bookshelf 1405, which also includes a crank 1406 for the raising and lowering of a solar panel 1408 which is attached to the body of the bookshelf 1403 by way of a hinge 1407 as depicted in FIG. 15. The solar panel moves as depicted in FIG. 16 into a position to catch the sun's rays so as to power the battery charger of the electronic bookshelf 1403. Such a unit may be useful for people who live in multidwelling buildings and do not have access to a roof upon which to mount solar panels.

The disclosed solar-powered electronic bookshelf may generally be described therefore as follows: a method for powering an electronic book device comprising the following steps: mounting a first electronic bookshelf in a window; deploying a first solar panel, said first solar panel being movably coupled to said electronic bookshelf; and powering a first battery charger with said first solar panel so as to recharge a battery in an electronic book device.

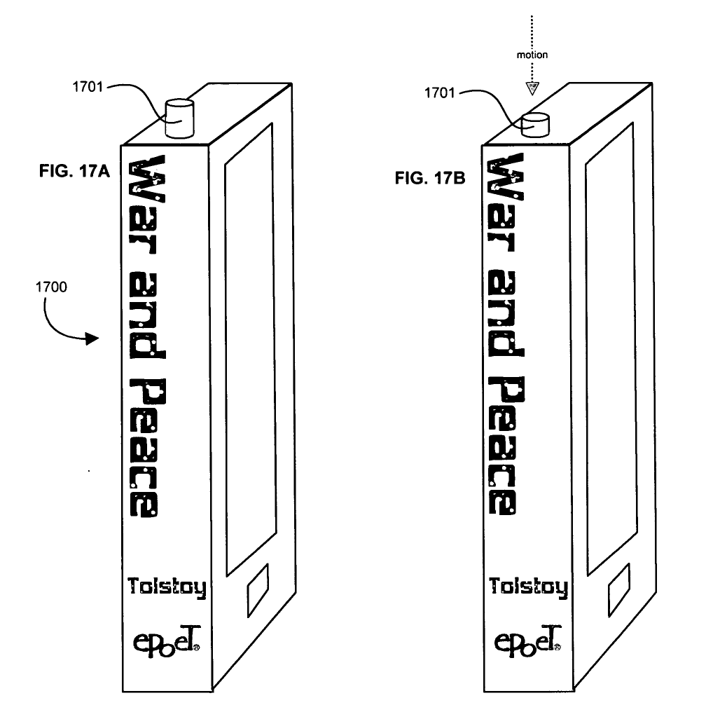

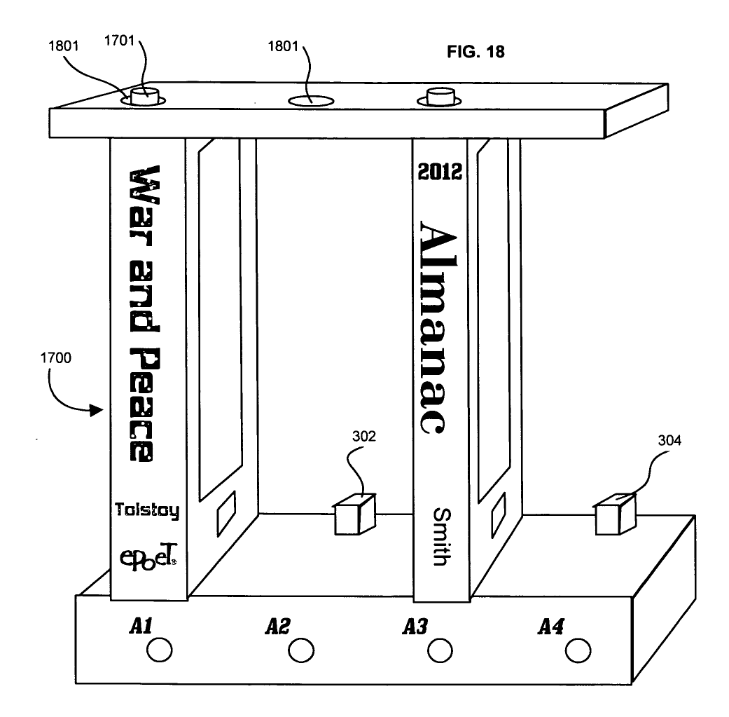

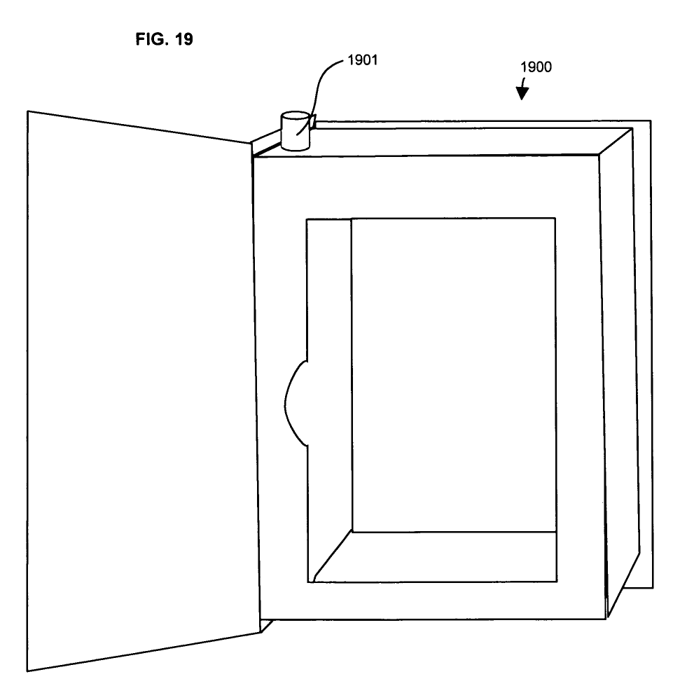

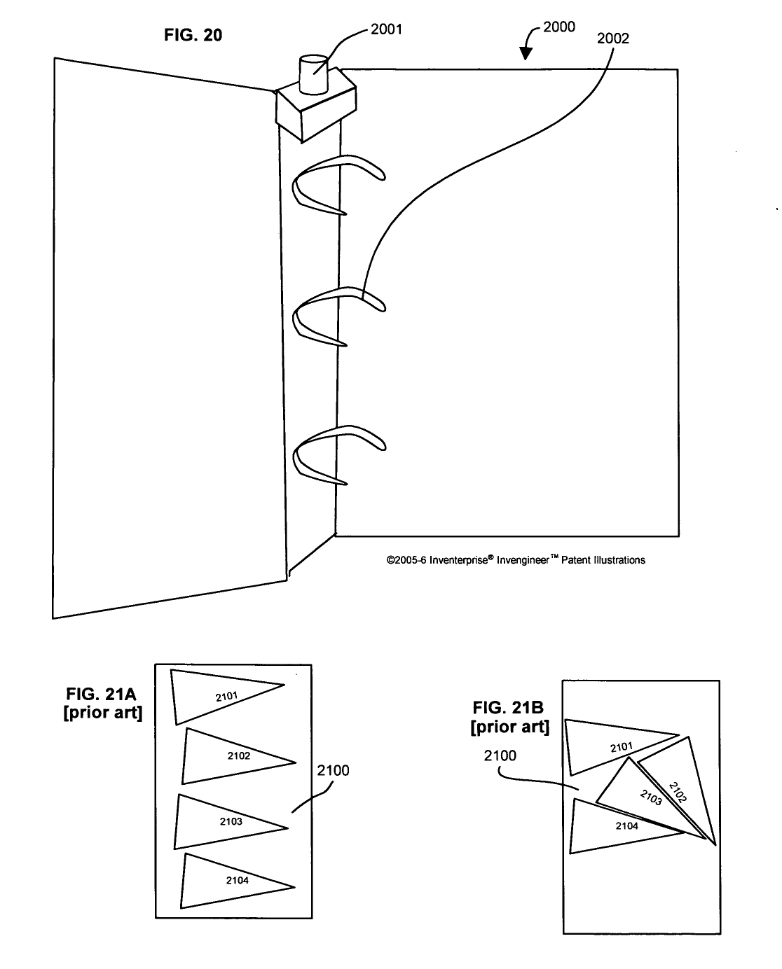

An alternate EBD 1700 provides a spring-loaded catching mechanism 1701 as shown in FIG. 17A. This mechanism 1701 can be depressed as pictured in FIG. 17B so that it protrudes to a lesser degree. Spring-loading causes the mechanism 1701 to extend back to its prior level of protrusion once released. This mechanism 1701 can be used to hold the reading device in place as depicted in FIG. 18: the mechanism 1701 is depressed, then the EBD 1700 is inserted into an electronic bookshelf that includes a number of perforations 1801, and then the mechanism 1701 is released so as to extend into one such perforation. EBD is then held firmly in place. A similar mechanism 1901 can be used on a book-look cover 1900 as shown in FIG. 19.

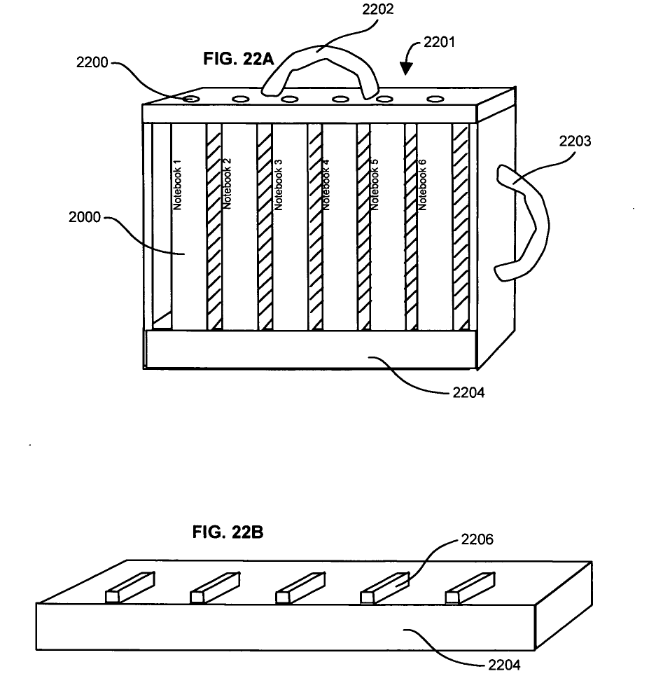

A similar mechanism 2001 may also be attached to a three-ring, looseleaf binder 2000 that includes rings 2002 for binding pages (not shown) that have been hole-punched. Such a mechanism may be particularly useful in the context of such binders, as illustrated in FIGS. 21A and 21B, which illustrate the related art from a bird's eye view. Under the related art, several looseleaf binders 2101-2104 are placed on a shelf 2100 as shown in FIG. 21A. However, over time, as these binders are removed from the shelf and then placed back on the shelf during a workday, their triangular shape causes them to tend get jumbled up as depicted in FIG. 21B, as anyone who uses such binders has probably experienced firsthand. But, by having a catch mechanism 2001 on the spine of such a binder 2000, this jumbling problem is eliminated. Through the use of such a catch mechanism, such binders 2000 can even be placed in a carrying case 2201 equipped with perforations 2200 as shown in FIG. 22A and carried about without becoming disorganized. The bottom shelf 2204 of such a case may contain slats 2206 to further enhance stability of the binders.

The disclosed stabilizing system may therefore be generally described as follows: a method for preventing disarrangement of a readable device, said method comprising the following steps: depressing a first spring-loaded mechanism, said first spring-loaded mechanism being attached to a first readable device, said first readable device being selected from the group consisting of (I) an electronic book device, (II) a cover for electronic book device, and (III) a looseleaf binder; inserting said first readable device into a first container, said first container being configured to receive said first spring-loaded mechanism; and releasing said first spring-loaded mechanism so that said first spring-loaded mechanism is inserted into a cavity or perforation in or formed by said first container.

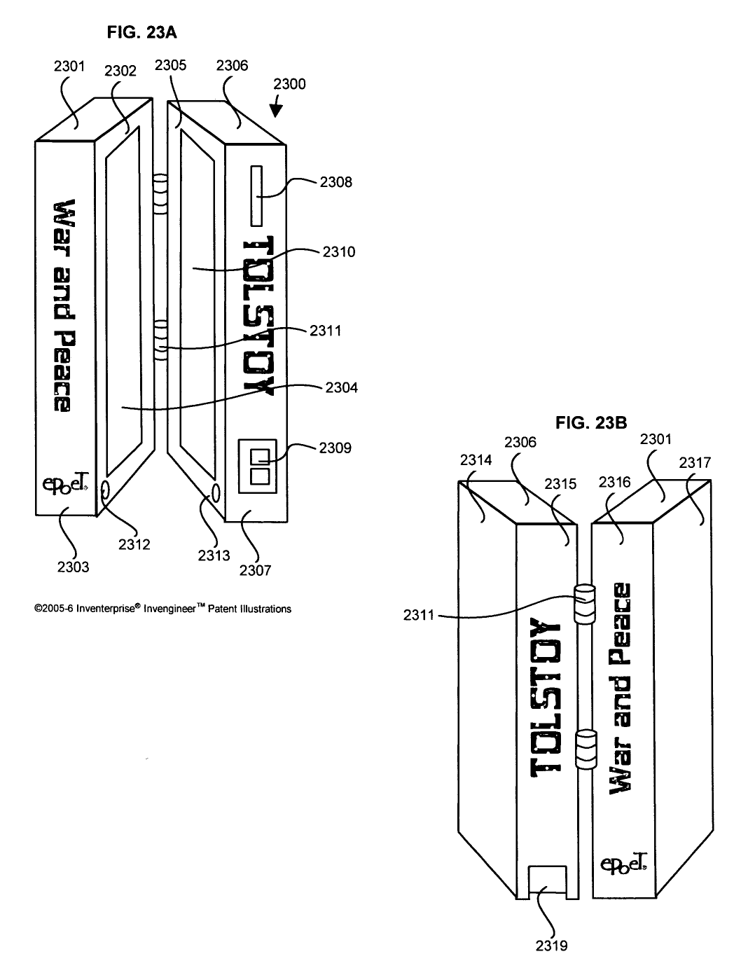

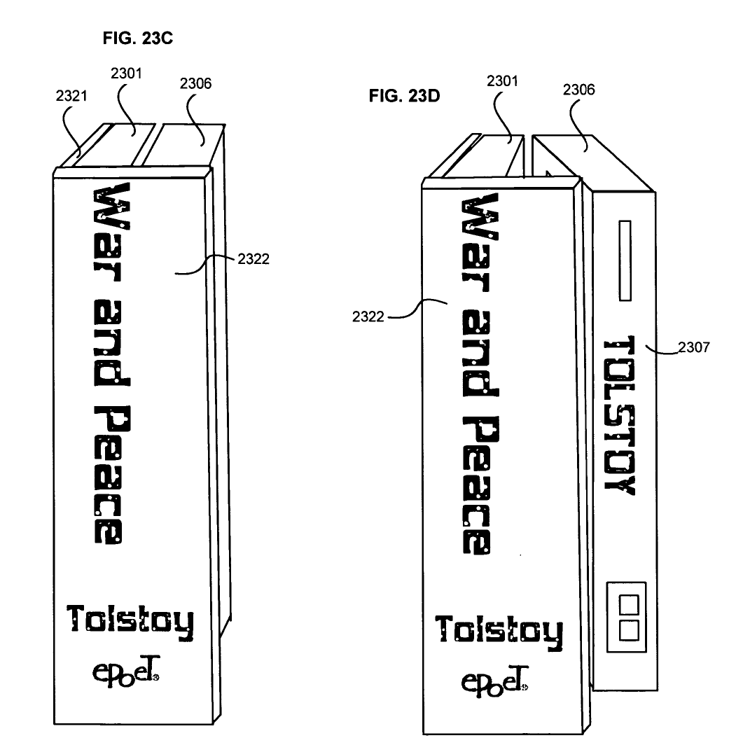

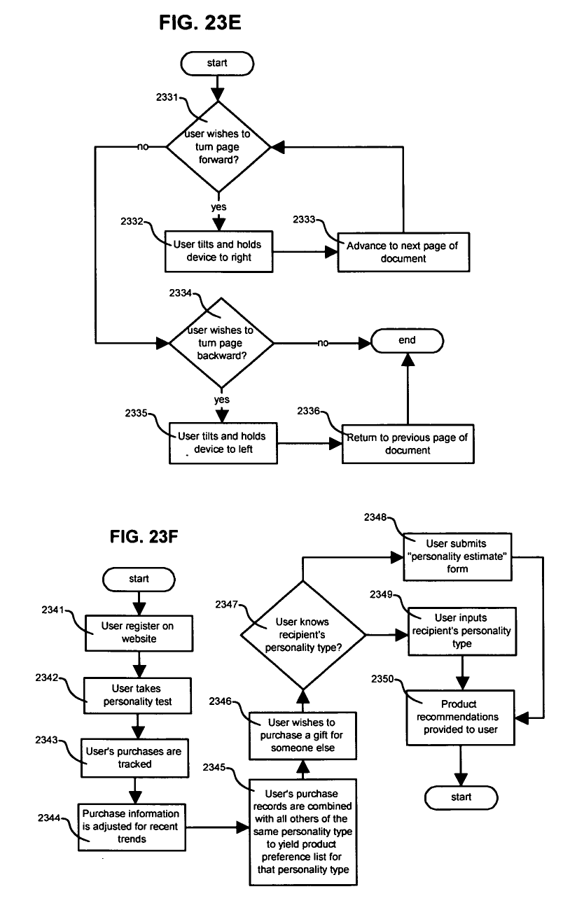

An alternate EBD 2300 is depicted in FIGS. 23A and 23B. This device provides two separate monitors 2304 and 2310 that are contained in two separate housings 2301 and 2306 that are joined together by hinges 2311. Such an arrangement allows two pages of the document to be displayed simultaneously so that they can be viewed as a spread, rather than as individual pages. One of the two monitor housings also includes a manual dial interface 2308 for rapid movement through large numbers of pages and a button interface 2309 for individual page turning. Pages can also be turned by touching two contact points 2312 and 2313 together briefly by briefly closing the device. A port 2319 for docking is included, and this port 2319 is oriented such that it cannot be seen when the user is reading.

Since this embodiment provides two separate housings that are hinged together, a different type of pseudo-spine is needed. Such a pseudo-spine 2322 as depicted in FIG. 23C. This attachment 2322 attaches to one 2301 of the two housings so as to cover the sides of both housings 2301 and 2306, except when the second housing 2306 is opened as depicted in FIG. 23D so as to reveal the monitors and manual interfaces, etc. Note that, while the pseudo-spine 2322 depicted attaches opposite the hinges, a similar mechanism (not shown) can be attached to the hinge side so as to cover the hinges instead. However, such an approach would obstruct the port 2319 or require a passthrough port as depicted in FIG. 8A, which would in turn detract from the appearance of the pseudo-spine.

Instead of a traditional manual interface, an environmental sensor, such as a gyroscope-based position sensor or digital level, may be included in an EBD so that pages can be turned simply by tilting the device to the right or to the left as depicted in the flowchart appearing in FIG. 23E. This method may be described generally as follows: a method for turning the receiving a first set of sensory data, said first set of sensory data being derived from the spatial orientation of a first electronic book device; and performing a navigation step, said navigation step being selected from the group consisting of (I) moving forward at least one page and (II) moving backward at least one page, wherein said step of performing a navigation step is made according to a comparison between said first set of sensory data and a standard, said standard being a second set of sensory data.

FIG. 23F depicts the steps of a disclosed process whereby EBD recommendations to potential customers interested in buying a gift for someone else are made with reference to the customer's intended recipient's personality type. A first user registers 2341 on a web site and takes 2342 personality test such as the Myers Briggs test, so as to group the user into one of sixteen groups (“ESFP”, for example) defined by a matrix of four binary traits (i.e., extrovert vs. introvert, sensing vs. intuitive, thinking vs. feeling, perceiving vs. judging). Thereafter, that user's purchases are tracked 2343 with particular emphasis being placed on recent purchases 2344. The user's purchase records are combined 2345 with the purchase records of all other users who have the same personality type to yield a product preference list for that personality type. Thereafter, when a second user wishes 2346 to purchase a gift for a third person, if he or she knows 2347 that person's personality type, he or she inputs 2349 this personality type into the system via the web site, and the product preference list is returned 2350 to the second user. If the second user does not know 2347 the third person's personality type, he or she can submit 2348 some answers to some questions through a Web submission form about the intended recipient so as to get a “personality estimate” for the intended recipient. Then the product recommendations list is provided 2350 based on the so-estimated personality of the intended recipient.

The disclosed product recommendation system can therefore be generally described as follows: a method for recommending products to a potential purchaser said method comprising the following steps: administering a first personality test, said first personality test being suitable for ascertaining the general personality type of a first user; tracking said first user's purchasing habits; aggregating purchasing data pertaining to a plurality of other users of the same general personality type of said first user; compiling a preference list for said personality type; and providing a list of product suggestions to a second user based on the personality type of a third user who is believed to be of the same personality type as said first user.

FIG. 25 depicts the steps of a “burn-on-demand” or, where applicable, “burn-and-print-on-demand” process for purchasing an EBD and completing manufacture of the EBD only after an actual purchase has been made. When a user finds a book he likes 2501, he calls a toll-free number 2502 and enters the ISBN 2503 of the book device. A database is queried and the title, price, etc. of the EBD are communicated to the user 2504. If the user wishes to buy the EBD 2505, he signifies his agreement 2506 and the call is forwarded 2507 automatically to a toll number (such as a “900” number) that is the appropriate predetermined toll number for the amount to be charged to the customer, so that the call is charged 2508 at the amount of the price of the book device. An example of the toll number is depicted in FIG. 25B: as depicted therein, the last four digits of the toll number equals the amount to be charged to the user's telephone bill (e.g., is $20.95 is to be charged, and the toll number to which the user's call is forwarded—for purposes of finalizing the transaction only—is 900-555-2095). All calls to a given toll number are charged at a single particular per-call rate, such that each phone number is assigned to a different rate and each rate is assigned to a different phone number 2500. The call then appears on the customer's regular telephone bill 2509 as any other toll-charged call. Once the user's order has been placed, a virgin reading device is loaded 2510 with the appropriate document so as to create the product that the user has purchased. The product is then shipped to the user 2511.

Disclosed burn-on-demand EBD system may therefore be generally described as follows: a method for manufacturing a dedicated electronic book device comprising the following steps: manufacturing a generic electronic book device; receiving a first customer order; loading a first document into the memory of said generic electronic book device in response to said first customer order; and dedicating said generic electronic book device, said step of dedicating being selected from the group consisting of (I) the step of displaying a title, an author or publisher of said first document via an electronic pseudo-spine, (II) the step of permanently printing indicia on said generic electronic book device, said indicia comprising at least a title or an author of said first document, and (III) storing a first location in said memory so that said location can be read by not modified.

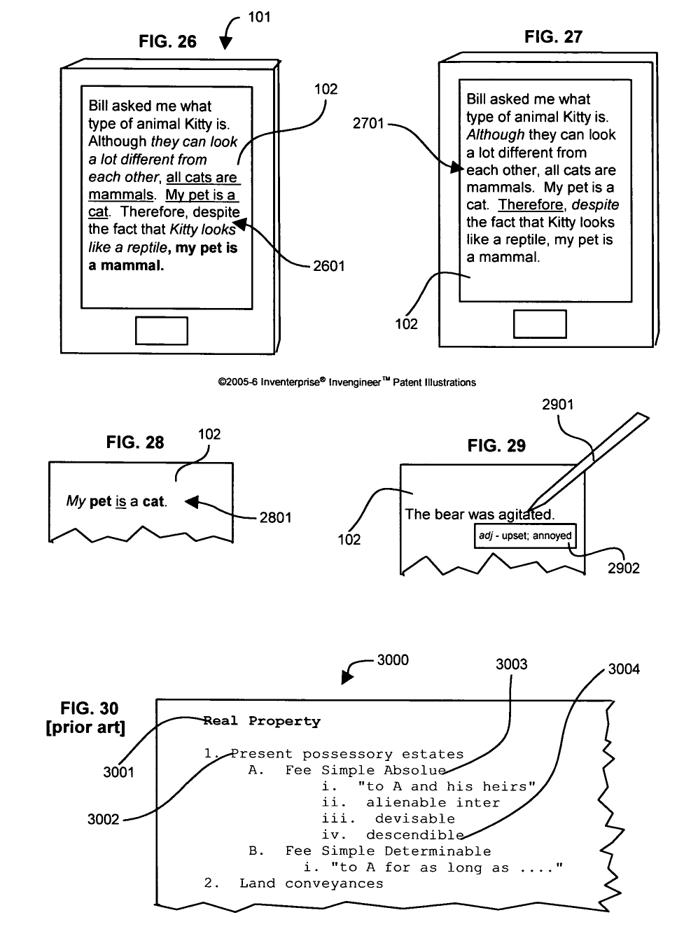

A series of documents that are designed for helping user prepare for standardized tests (LSAT, bar exam, GRE, SAT, etc.) is disclosed in FIGS. 26-29. A document 2601 is displayed in the monitor 102 of the EBD 101 in such a way that premises of an argument are underlined or displayed in a first color (e.g., red) and the conclusion of an argument is bold-faced or displayed in a second color (e.g., blue) as shown. Counter-evidence or information that undermines the argument is displayed in italics or a third color (e.g., green). An alternate embodiment 2701 of this document provides that structural indicators of contrast or counter-arguments (“although” and “despite”, for instance) are displayed in italics or a first color and structural indicators of continuity or conclusions (“therefore”, for instance) are underlined or displayed in a second color, while indicators of premises (“because” for “since”, for instance) are bold-faced or displayed in a third color. Another alternate embodiment 2801 of such a document provides that different parts of speech are displayed in different font styles or colors, such that, as shown, nouns are bold-faced and verbs are underlined, etc. In another alternate embodiment, the monitor 102 is touch sensitive, and the memory of the EBD comprises an electronic dictionary or a document marked-up according to the example depicted in FIG. 47D such that, when a word being displayed by the monitor is touched with a stylus 2901, a pop-up window 2902 appears with a dictionary definition of the word touched.

Additional study techniques are also disclosed. In FIG. 30, a fragment 3000 of an academic outline under the related art is depicted. In such a conventional outline, a title 3001 indicates the subject matter of the outline, a first level heading 3002 indicates a major point, a second level heading (“subheading”) 3003 indicates a significant point that is related to the major point above it, and a third level heading (“sub-subheading”) 3004 indicates a detail that pertains to the significant point above it. Additional levels can be added to the hierarchy of such an outline as necessary. As described above, however, such an approach does not accurately reflect the way the human mind works and is therefore a suboptimal study tool.

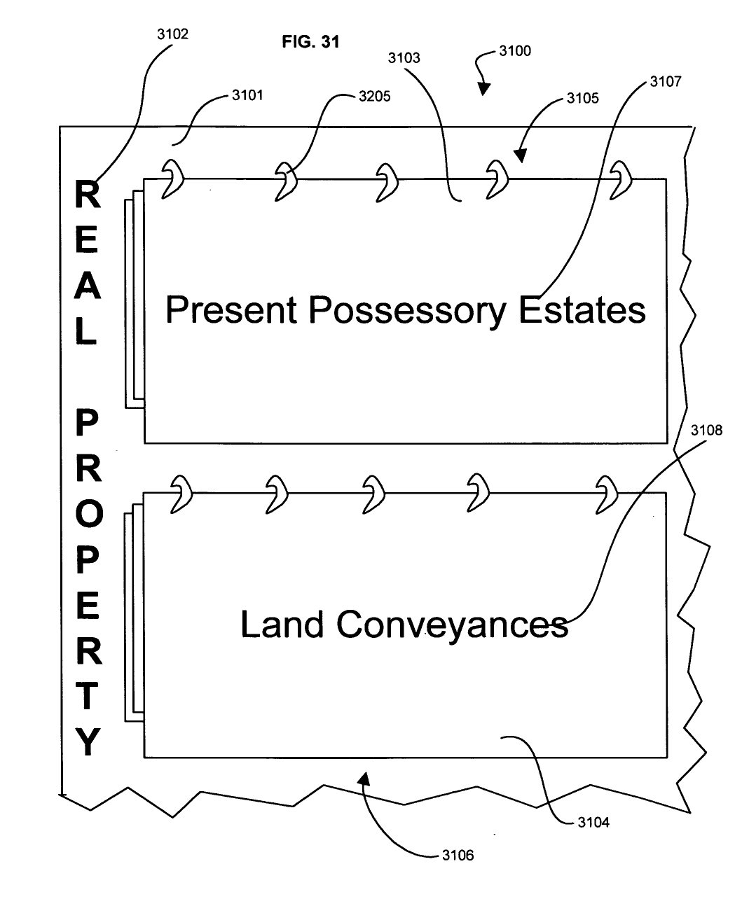

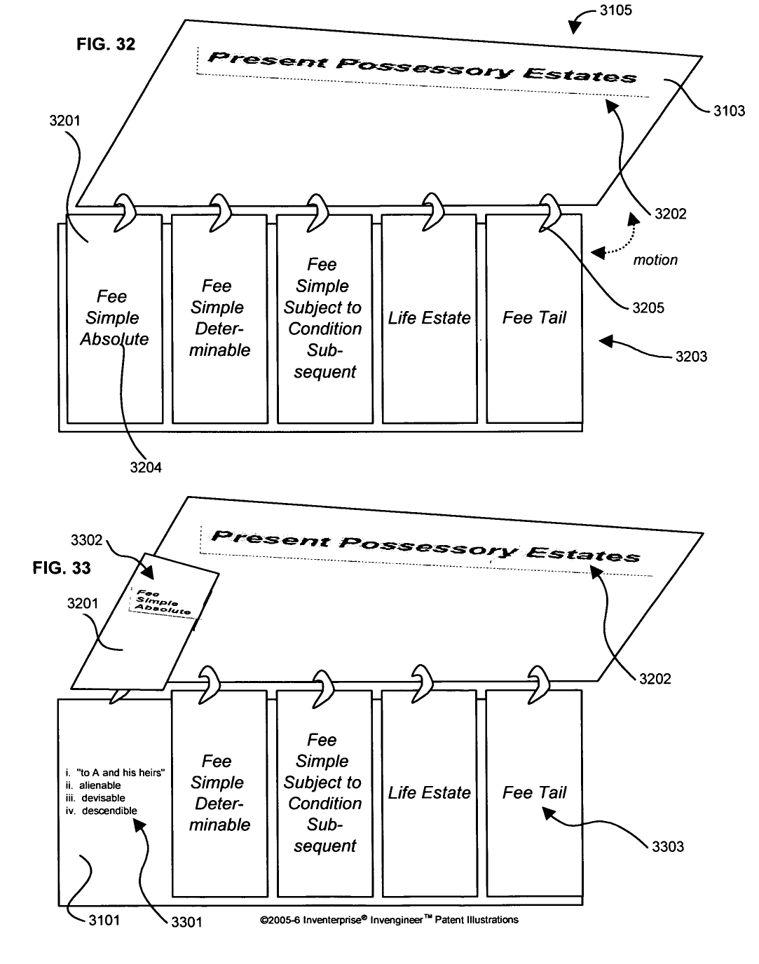

A superior study tool is depicted in FIG. 31 et seq. This device 3100 provides a flat, sturdy base sheet 3101 made of cardboard, plastic, wood or similar material upon which indicia 3102 indicating the subject matter to be studied appear. Mounted upon this base 3101 is a first study module 3105 and a second study module 3106, these modules being two of many mounted upon the base 3101. The first study module 3105 has a cover sheet 3103, and the second study module 3106 has a cover sheet 3104, each such sheet bearing indicia 3107 and 3108 that indicate a first level heading that corresponds to a first level heading in a conventional outline. Unlike a conventional outline, material is thereafter arranged three dimensionally rather than two dimensionally or sequentially. Thus, for instance, in order to access second level headings in the first study module 3105, a user raises the cover sheet 3103 as depicted in FIG. 32. This sheet 3103 rotates on an axis described by comb binding, spiral binding, or hinges 3205 to reveal a plurality of additional sheets 3203, each of which bears indicia 3204 that indicate a second level heading. Meanwhile, the underside of the cover sheet 3103 bears a duplicate indicium 3202 so that a user can see simultaneously both the first level heading and the second level headings that pertain to it. Such an arrangement more accurately reflects the workings of the human mind since it puts concepts of equal priority on an equal footing and allows users to “drill down” on a particular topic when details of that specific topic need to be accessed. The present invention, in other words, provides a much more true form of “random access” information structure than a conventional sequential outline, such as that depicted in FIG. 30, can provide.

Thereafter, a user can raise a sheet 3201 bearing a second level heading, this sheet rotating about an axis described by comb binding, spiral binding, or hinge, as depicted in FIG. 33 to reveal indicia indicating third level headings 3301 that pertain to the given second level heading 3302. Note that the underside of the second level heading sheet 3201 bears a duplicate indicium 3302 so that the user can simultaneously see the first level heading 3202 indicium, second level heading indicium 3302, and third level heading indicia 3301. Third level heading indicia 3301 can be printed directly on the base 3101 if there are no fourth level indicia that would need to be established at a third layer of movement. This arrangement again allows the topic being explored in detail to be set in a context of higher-level concepts, since the other second level headings 3303 are still also visible to the user, while the detail clutter pertaining to these other second level concepts remains hidden so as not to confuse the user. Moreover, a user can drill down in another area, if he or she desires, by lifting another second level sheet to reveal and compare the details of two related concepts.

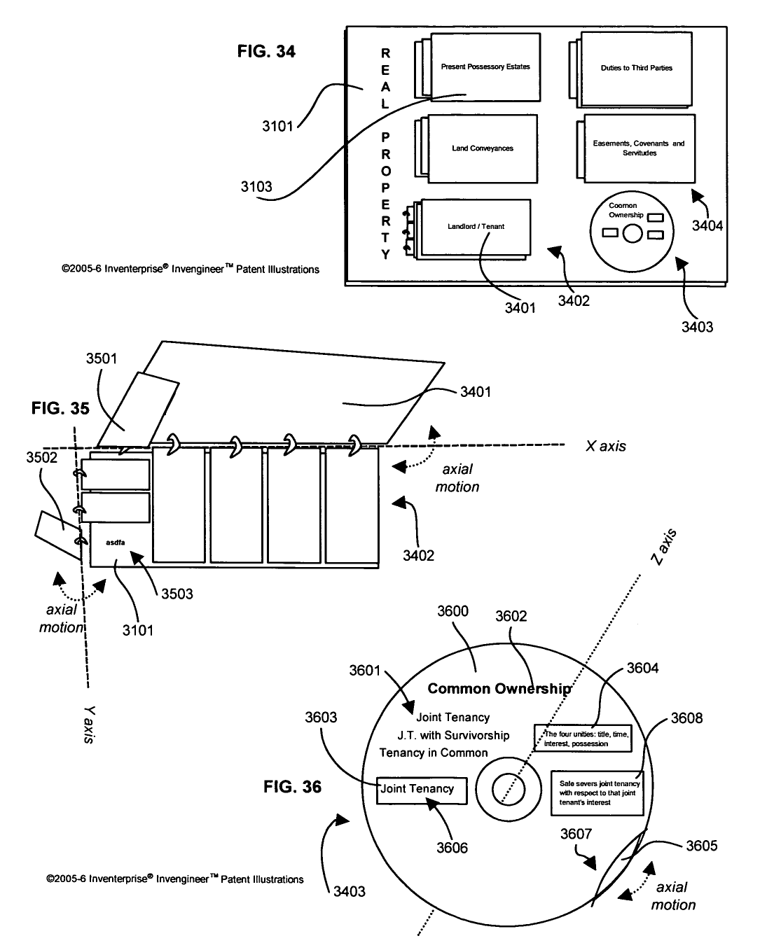

So as to further enhance the utility of the present invention in helping students learn and retain information, other modules provide different forms of motion, such as rotation along different, nonparallel axes or motion that does not involve rotation. These modules are situated on the baseboard as depicted in FIG. 34. Each such module, nonetheless, is designed to provide context of higher and lower concepts and three-dimensional random accessibility. The selection of which types of modules, which types of motion, and how many sheets to use in a given device should be made according to several selection criteria, including: how many subheadings appear under a given heading; how complex is the subject matter under that heading; and what other modules will appear on the device. It is important to have a diversity of module types in a given device —preferably each module having a different predominant color (red module, blue module, green module, etc.)—so as to further enhance the memorizability of the material being study. For instance, it will be easier to remember the “Present Possessory Estates” module if it is green and contains axial motion as depicted in FIGS. 32 and 33 while other modules are not green and use a different kind of motion. The human brain likes eccentricity and retains it easier than it does material that is presented monotonously; thus making each module eccentric or unique in some way assists the user's recall of the subject.

FIG. 35 depicts another module 3402 in detail, including a first level heading sheet 3401 (a “cover sheet”) that rotates along a first axis to reveal a plurality of second level heading sheets; a second level heading sheet 3501 (an “intermediate sheet”) that rotates along the first axis to reveal a plurality of third level heading sheets 3502; a given third level heading sheet 3502 (also an “intermediate sheet”) rotates along a second axis which is substantially perpendicular to the first axis to reveal an indicium 3503 of a fourth level heading that is printed on the base 3101.

Another module 3403 is depicted in FIG. 36. This module 3403 includes a circular cover sheet 3600 upon which are printed an indicium of a first level heading 3602 and indicia 3601 of a plurality of second level headings. A second or intermediate circular sheet 3605 is partly covered by the first circular sheet 3600 such that only a portion of the underlying sheet 3605 can be seen through a first window 3603. The second circular sheet can be manipulated through a cutout portion 3607 of the first sheet so as to position—by rotation about a Z axis that is third-dimensional relative to the X and Y axes described above—the second level sheet 3605 such that one of the second level headings 3606 can be seen through the first window 3603 that has been diecut out of the cover sheet 3600. When the two sheets 3605 and 3600 are so positioned relative to each other, third level headings pertaining to the second level heading 3606 appearing in the first window can be seen through two additional windows 3604 and 3608. This design allows the levels of headings to be viewed simultaneously and for one subheading to be explored in more detail. Optionally, the windows 3606, 3604 and 3608 can be covered with a translucent, colored cellophane layer, so that only certain text can be read through these windows (namely, text that is printed in a color that is not the color of said cellophane), thereby allowing more information to be printed on the second sheet 3605 while only certain printed information is visible through a given window.

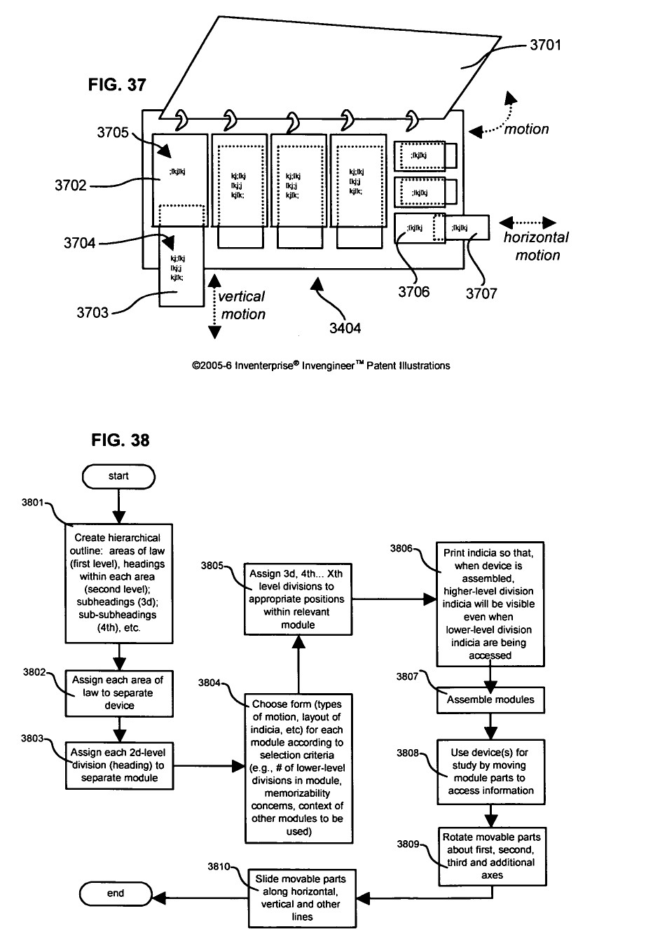

Another module 3404 appears in FIG. 37. This module provides a first level heading sheet 3701 that rotates around a first axis, second level heading sheets 3702 that are, in combination with the base member, essentially envelopes or sheaths that are fixed permanently on to the base 3101 so as to allow third level heading sheets 3703 to slide in and out of these sheaths 3702 in a first linear direction. Indicia 3705 appear on the second level sheets, and indicia 3704 appear on the third level sheets, but third level sheet indicia can only be seen when the third level sheet is extracted from the sheath formed by the second level sheet. Supplementary information is provided in another series of second level sheets 3706 that are also sheaths arranged so as to allow third level sheets 3707 to move in and out along a second linear direction. Thus, this module comprises a first rotational element, a first linear movement element along a first line and a second linear movement element along a second line, said second line being substantially perpendicular to said first line. Taken as a whole, the study device 3101 therefore provides rotational movement along three different axes that may be described as an X axis (e.g., for 3401 motion), a Y axis (e.g., for 3502 motion), and a Z axis (e.g., 3605 motion) and may provide pivoting motion about non-perpendicular, nonparallel lines that do or do not lie in a plane with each other, if needed, through the addition of jointed base members, for instance. The study device also provides linear movement along a path that may be described as horizontal (e.g., for 3707) and a path that may be described as vertical (e.g., for 3703 motion) and may provide linear motion along non-perpendicular, nonparallel lines that do or do not lie in a plane with each other. The study device also provides intermediate sheets that are sandwiched between cover sheets and the base member, as well as intermediate sheets that are sandwiched between higher-level intermediate sheets and the base member.

FIG. 38 depicts a process whereby such a study device is created and used. A hierarchical outline of a given area of law is created 3801. Each area of law is assigned 3802 to a different separate device, such as the device pictured in FIG. 34. A first level division (heading) is assigned 3803 to a separate module, such as module 3402. A form is chosen for each module 3804 depending on selection criteria, such as how many divisions appear under the given heading, what other modules are to be used, etc. For each module, lower-level divisions are assigned 3805 appropriate positions within each module. Indicia are printed 3806 in accordance with the chosen form so that each portion is ready for assembly. The modules are assembled 3807 into a device. And then the devices used 3808 as described above.

This portion of the present invention may therefore be generally described as follows: A method of learning a first subject (e.g. real property law) said method comprising the following steps: creating an outline, said outline comprising at least a first main topic (e.g., present posessory estates) within said subject and a second main topic (e.g., land conveyances) within said subject and at least a first subtopic (e.g., fee simple absolute) within said first main topic;

assigning said first subject to a first apparatus 3100, said apparatus comprising a base member 3101 and a plurality of movable members (e.g. 3103-3104) movably coupled to said base member; affixing an indicium 3107 of said first main topic on a first movable member; affixing an indicium 3108 of said second main topic on a second movable member; affixing an indicium 3204 of said subtopic on a third movable member; performing a first movement step, said first movement step further comprising the step of rotating said first movable member about a first line (e.g., x-axis in FIG. 35); performing a second movement step, said second movement step further comprising the step of rotating said second movable member about a second line (e.g., y-axis in FIG. 35), said second line being distinct from said first line; and performing a third movement step, said third movement step further comprising a step selected from the group consisting of (i) the step of rotating said third movable member of about a third line (e.g., z-axis in FIG. 36) and (ii) the step of sliding said third movable member along a third line (e.g., horizontal motion line in FIG. 37), said third line being distinct from said first line and from said second line.

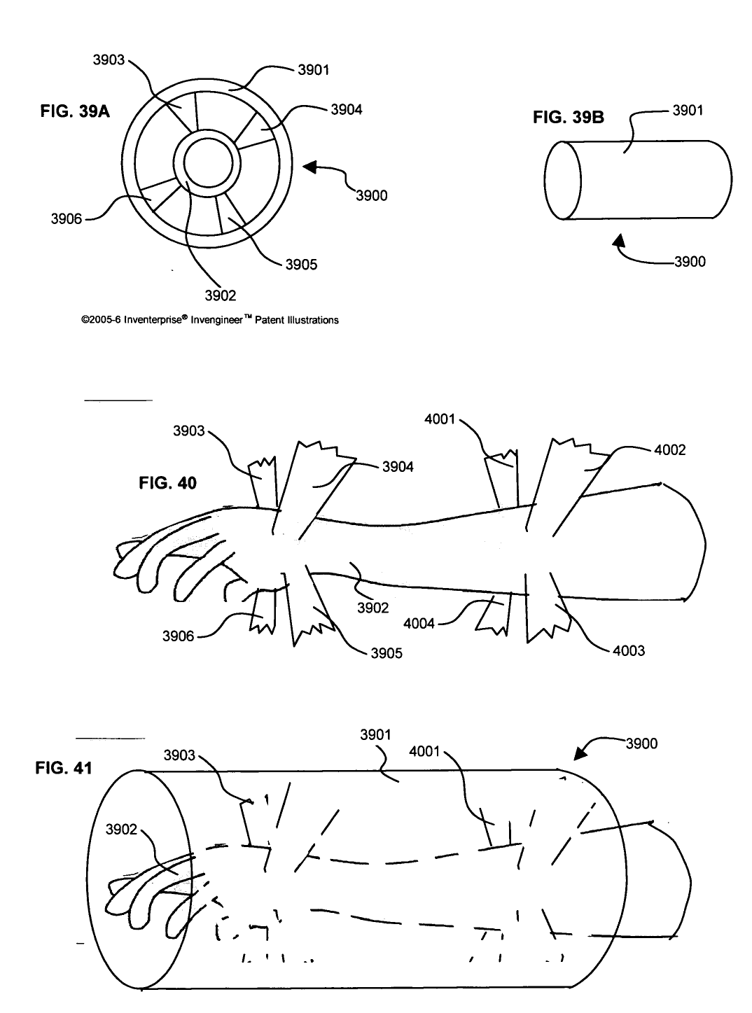

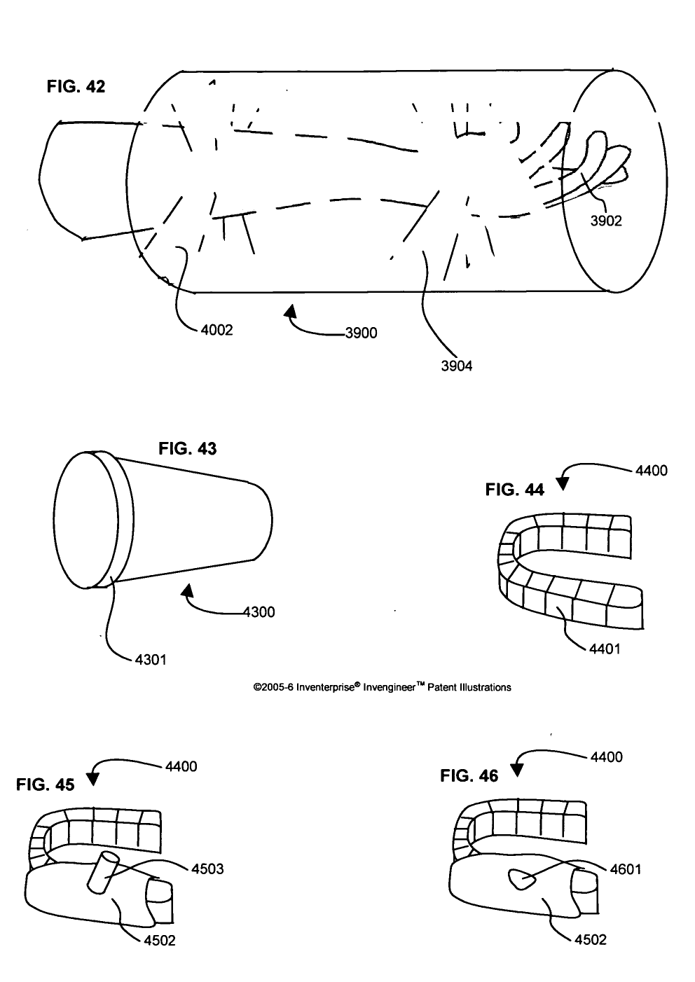

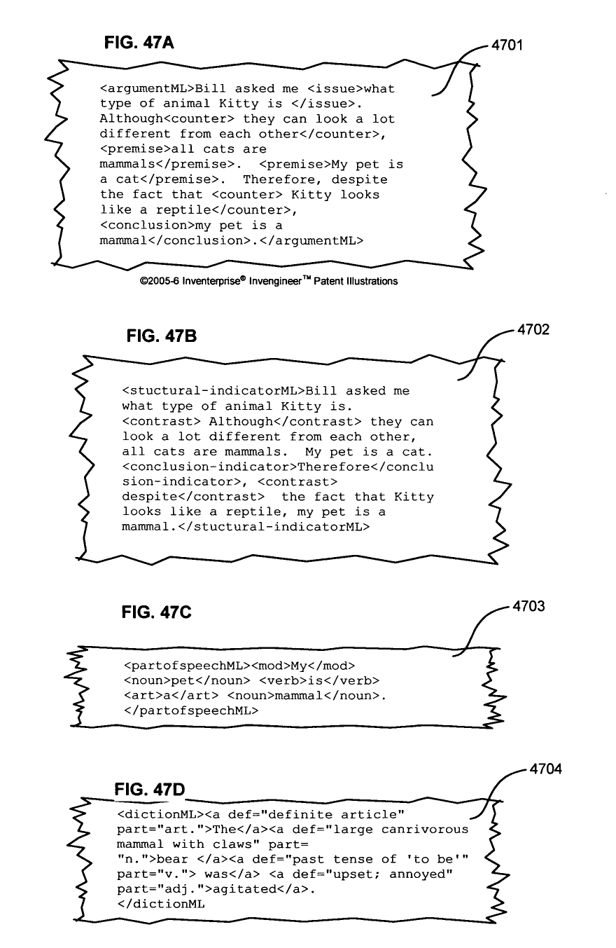

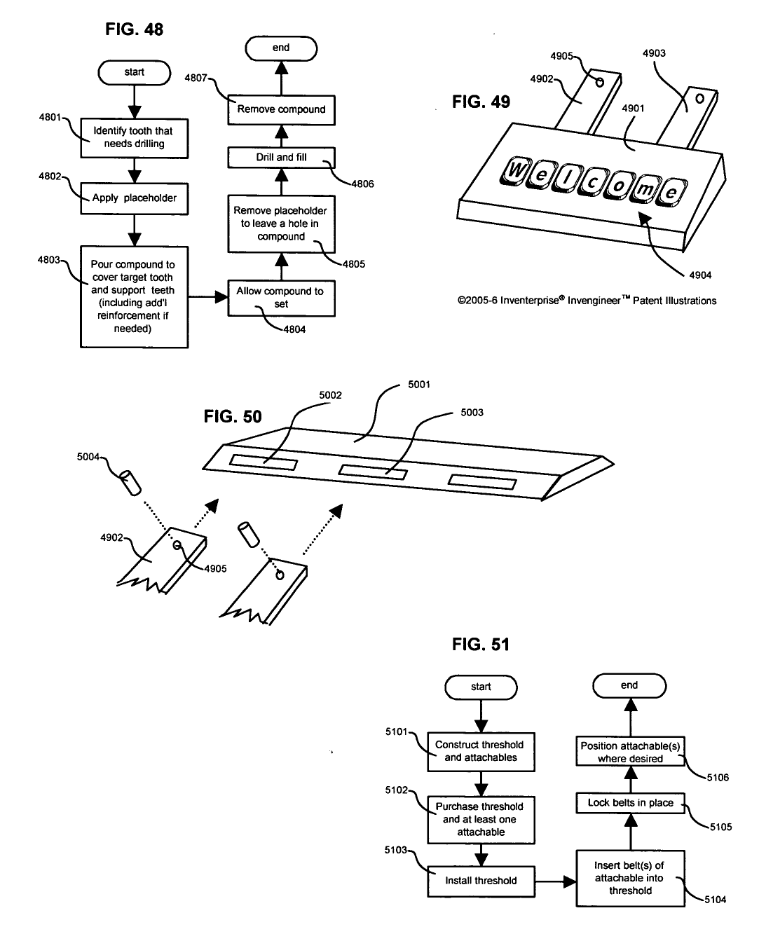

Peace of mind is a big factor in determining the quality of one's studying or reading experience. Therefore a number of health and safety enhancements are also disclosed. For those EBD users suffering from a broken limb, a superior limb suspension device 3900 is disclosed in FIG. 39. FIG. 39 shows a cross-section of the limb suspension device 3900, which provides an outer shell 3901, made of plastic or similar semi-rigid material, to which are attached several straps 3903-3906. Suspended from multiple directions (which may described as top, bottom, left and right, or 12 o'clock, 3 o'clock, 6 o'clock, and 9 o'clock positions relative to each other) by these straps 3903-3906 is a glove 3902 into which a user can insert his or her hand and arm. (An alternative embodiment, not pictured, provides a sock for those who need to suspend a leg rather than an arm.) The glove 3902 is depicted from the side in FIG. 40, along with the straps 3903-3906 that were visible in FIG. 39 as well as another set of straps 4001-4004 that support the glove 3902 at a different location. FIG. 41 shows the shell, 3901 glove 3902 and straps when the device is in a first orientation. FIG. 42 shows the device in a second orientation. In both the first and second orientations, the glove 3902 is equally suspended even though the orientation of the outer shell has changed (e.g., a “3 o'clock” strap has moved into “9 o'clock” position). In this way, a user of the device can lie on his or her stomach for a while and then lie on his or her back for a while while yet keeping the affected limb suspended at all times. An alternative limb suspension device 4300 provides an outer shell that is shaped like a megaphone rather than like a regular cylinder. This alternative also provides a rotating ring 4301 that further allows for easy sliding of the device when rested upon a surface by the wearer.

The disclosed limb suspension device may therefore be described generally as follows: a housing, said housing being selected from the group consisting of (I) a cylindrical housing and (II) a conical housing; a limb sheath, said limb sheath being selected from the group consisting of (I) a sheath suitable for accommodating a hand and arm, such as a glove, and (II) a sheath suitable for accommodating a foot, such as a sock; a suspension mechanism, said suspension mechanism configured so as to suspend said limb sheath inside said housing such that the center of the sheath remains substantially equidistant from opposite sides of said housing regardless of orientation of the housing.

For those EBD users suffering from a dental cavity, a system for protecting against gum damage caused by drilling and filling a cavity is disclosed. FIG. 44 depicts the teeth 4400 of a user, including a tooth 4401 that has been targeted 4801 for a filling. Prior to the filling operation, a placeholder 4503 is attached 4802 to the area to be drilled and a liquid compound 4502 is poured 4803 onto the affected tooth and surrounding teeth as depicted in FIG. 45. After the compound 4502, which is the same as or similar to the compound used to take molds of patients' teeth for the fitting braces or mouthpieces, has hardened 4804, the placeholder 4503 is removed 4805 so as to leave a hole 4601 in the compound through which a dentist can access 4806 the targeted drilling area of the affected tooth 4401 with a drill. Once the operation is complete, the compound 4502 is removed 4807 from the patient's mouth. This approach has several advantages: the mass of the solidified compound helps dissipate or absorb some of the vibration from drilling; the rigidity of the compound anchors the affected tooth to neighboring teeth, thereby allowing the neighboring teeth to support the affected tooth against pressure exerted by the drill; the compound itself provides a protective covering over neighboring areas to guard against inadvertent contact of the drill with areas that are not intended for contact (e.g., the gums or other teeth).

The disclosed gum damage prevention system may be therefore described generally as follows: a method of preventing oral damage comprising the following steps: identifying a first tooth; placing a first marker on said first tooth; pouring a first material on and around said first tooth, so as to substantially cover a portion of said first tooth and at least a second tooth; allowing said first material to set; removing said first marker so as to expose a portion of said first tooth; performing work on the exposed portion of said tooth; and removing said first material.

FIGS. 47A through 47D disclose alternative markup language techniques for displaying documents in the disclosed EBD system. FIG. 47A depicts an excerpt from a disclosed “argument markup language” document which, when displayed through the EBD, produces the result depicted in FIG. 26. In particular, counter evidence is tagged with the disclosed “counter” open and close tags, and information within such tags is displayed in italics or a first color as shown in FIG. 26. Additional tags such as disclosed “premise” and “conclusion” tags designate information that is to be displayed in a different font style or color. FIG. 47B depicts an excerpt from a disclosed “structural indicator markup language” document which, when displayed through the EBD, produces the result depicted in FIG. 27. In particular, a disclosed “contrast” tag designates information to be displayed in italics or a first color, while a disclosed “conclusion-indicator” tag designates information to be displayed in underlined form or a second color. FIG. 47C depicts an excerpt from a disclosed “parts of speech markup language” document which, when displayed through the EBD, produces the result depicted in FIG. 28. A disclosed “noun” tag, for instance, designates certain words as nouns, which are displayed in a first font style or color, while a disclosed “verb” tag designates certain words as verbs, which are displayed in a second font style or color. FIG. 47D depicts an excerpt from a disclosed “dictionary markup language” document which, when displayed through the EBD, produces the result depicted in FIG. 29. In particular, a disclosed “definition” (“def”) tag designates a particular word and then specifies a definition through an attribute of the tag such that the definition so specified appears when the word is touched on the touch sensitive screen of the EBD.

The disclosed markup language document system can therefore be generally described as follows: providing a markup language document, said markup language document comprising nested metadata tags as well as content described by said metadata tags; loading said markup language document into a data processing and display device; and performing a first display step, said first display step being selected from the group consisting of (I) displaying parts of speech according to said metadata tags, such that words or phrases tagged as verbs, nouns and modifiers are displayed differently from each other, (II) displaying structural indicators according to said metadata tags, such that words or phrases tagged as contrast indicators, premise indicators, continuity indicators, conjunctions, and conclusion indicators are displayed differently, (III) displaying parts of arguments according to said metadata tags, such that words or phrases tagged as premises, counter-evidence, issues, and conclusions are displayed differently and (IV) displaying definitions according to said metadata tags, wherein the definition of a first word or phrase is specified in an attribute of a metadata tag.

For those EBD users who wish to to read with the peace of mind that comes from knowing that one's belongings are safe, a system for guarding against theft of patio furnishings is disclosed in FIG. 4950. A welcome mat 4901 provides indicia 4904 and two flexible straps 4902-4903. A door threshold 5001 includes a number of slots 5002 and 5003 into which the straps 4902 and 4903 of the welcome mat can be inserted. After the threshold 5001 and attachables, such as the welcome mat 4901, have been constructed 5101, a user purchases 5102 the threshold 5001 and at least one attachable, such as the welcome mat 4901. Other attachables suitable for attaching to the threshold include: a pot or planter into which a plant can be planted; a piece of furniture such as a patio table or chair; a statuette or figurine; a doghouse; a swingset or other toy; or other object is typically kept outside. The threshold 5001 is then installed 5103 in the front doorway or other doorway closest to where the attachables will be used. The belts or straps 4902 and 4903 of the attachables are then inserted 5104 into the slots 5002 and 5003 of the threshold 5001. These belts or straps 4902 and 4903 are then locked 5105 into place using a peg 5004 that is inserted into a hole 4905 in each strap 4902 and 4903; this locking into place can also be achieved through the use of a clamp, buckle, or other conventional fastener. Then the attachables are positioned 5106 on the patio or in the yard and used as the user wishes, with peace of mind that the given attachable is now more difficult to steal.

The disclosed door threshold system may therefore be described generally as follows: a method of preventing theft comprising the following steps: installing a first door threshold, said first door threshold configured to receive a first belt; inserting said first belt into said door threshold, said first belt being attached to a first valuable item, such as a chair, a doormat, a pot, or an ornament; and securing said belt from a first side of said threshold, said first side of said threshold being accessible from inside a first house when a first door is closed but not being accessible from outside said first house when said first door is closed.

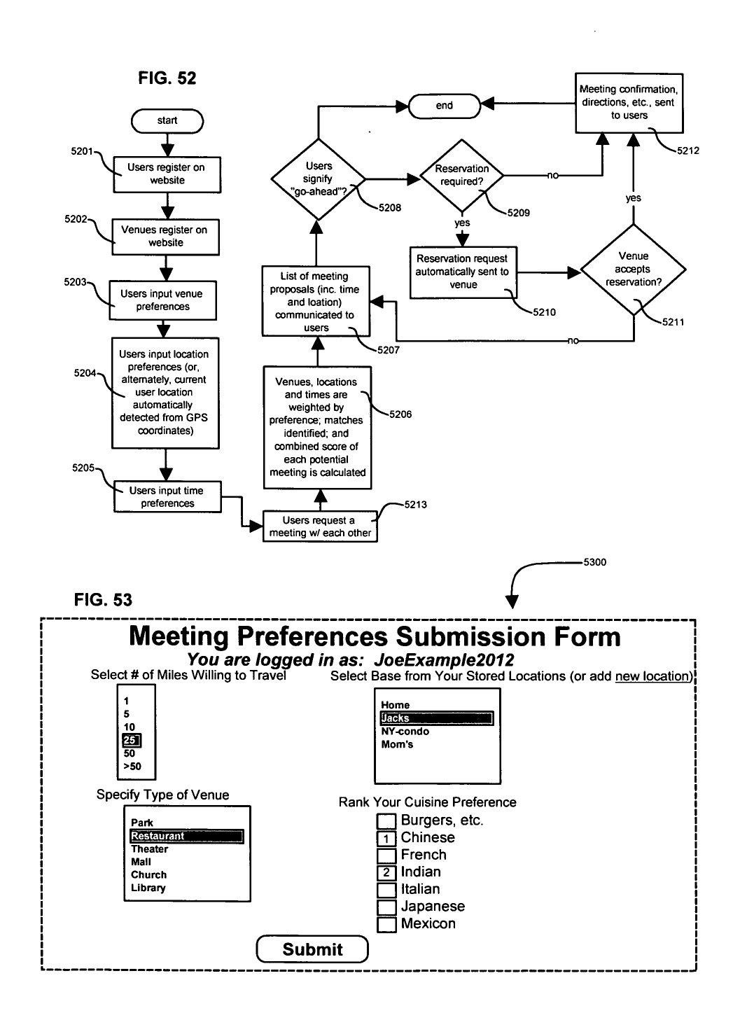

For those EBD users who wish to meet other EBD users at a public location, an Internet-based meeting arrangements system is depicted in FIGS. 52 and 53. Users visit and register 5201 on a web site to become a “subscribing user”, paying a fee if required by the web site provider. The owners of potential meeting places, venues such as restaurants, movie theaters, etc., also register 5202, providing location and hours of operation, etc., for their venues to become a “subscribing venue”, paying a fee if required by the web site provider. Subscribing users then input 5203 their preferences with respect to types of venues, input 5204 their preferences with respect to location and acceptable travel radius, and input 5205 their preferences with respect to potential times of day through a Web submission form such as that 5300 depicted in FIG. 53. When two users indicate through the web site that they wish to meet one another 5213, venue, location and time preferences of the two parties are matched and weighted to produce 5206 a combined score for each potential meeting, including both place and time and defaulting for having the parties “meet halfway” in terms of travel distance. A ranked list of proposed meeting places/times is then provided 5207 by e-mail or Web or text message to the users. If the users indicate their mutual assent 5208 to a meeting, and a reservation is required 5209 at the given meeting place/time, a reservation request is automatically sent 5210 to the venue contact information provided by the subscribing venue at registration. If the subscribing venue then accepts 5211 the reservation, or if a reservation is not required 5209, a meeting-confirmation message with directions etc. is sent 5212 to the users. The disclosed example Web submission form 5300 depicted in FIG. 53, for instance, provides a pop-up menu from which a user can select one of his or her stored locations; a mileage radius from the given selected location within which he or she is willing to travel to meet others; a preferred type of venue; and a preferred type of cuisine when the venue is a restaurant. Additional forms for adding a new store location, adding new types of venues, etc., may also be provided.

The disclosed meeting arrangement system may therefore be described generally as follows: a method for arranging meetings between two or more people comprising the following steps: providing a Web submission form accessible via the World Wide Web; receiving a first submission from a first user, said submission comprising at least a first piece of information and a second piece of information, said first piece of information and said second piece of information being selected from the group consisting of (I) a time or time range, (II) a type of meeting place, such as a restaurant, movie theater, or library, (III) a travel radius, and (IV) a base location, such as the location of the first user's home or office; receiving a second submission from a second user; assigning a first score to each of a plurality of potential meetings, said first score being based at least in part upon said first submission; assigning a second score to each of a plurality of potential meetings, said second score being based at least in part upon said second submission; combining said first score and said second score to produce a third score for each of a plurality of potential meetings; providing to said first user and to said second user a ranked list of potential meetings, the rankings thereof being based at least in part upon said third score of each potential meeting; and receiving a third submission from said first user and a fourth submission from said second user, each of said third submission and said for submission comprising a confirmation of acceptance of one of said potential meetings.

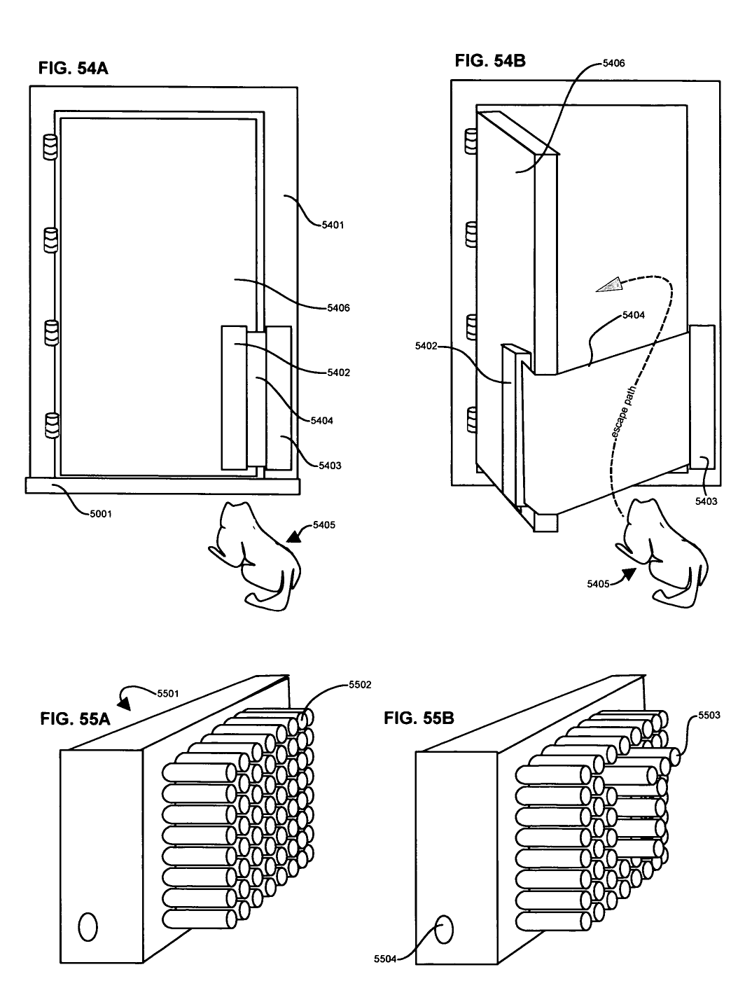

Those EBD users who do indeed go to meet others through the use of the above meeting-arrangement system can have additional peace of mind knowing that their pet has not escaped through the use of a pet-escape prevention system disclosed in FIGS. 54A and 54B. A first housing 5402 and a second housing 5403 are attached to a door 5406 and a door frame 5401 respectively. The above-described threshold 5001 is installed below the door 5406. Attached to the two housings 5402 and 5403 is a portion 5404 of flexible fabric that stretches when the door 5406 is opened as depicted in FIG. 54B. This fabric member 5404 obstructs the direct escape pathway of a pet 5405 when the door 5406 is open such that the only remaining escape path for the pet 5405 is to jump over the fabric member 5404. While such an obstruction does not prevent the pet from escaping, it does discourage and hinder escape while doing little to obstruct the use of the door by people, who can simply step over the fabric 5404. Instead of using flexible fabric for the fabric member 5404, the fabric member can be mounted on a spring-loaded roller within one of the housings so that any slack is automatically taken up when the door is closed but can be let out when the door is opened. The first housing 5402 can also be removably mounted on the door so that it can be removed from the door and stored on the second housing 5403 when pet escape prevention is not needed.

The disclosed pet escape prevention system may therefore be generally described as follows: a first door; a first floor; a first housing suitable for mounting upon said first door such that a portion of said first housing is disposed proximate to the edge of said door that is closest to said floor; a first door frame; a second housing suitable for mounting upon said first door frame such that a portion of said second housing is disposed proximate to said floor; and a blocking member coupled to both said first housing and said second housing, said blocking member being selected from the group consisting of (i) a stretchable member made out of elastic fabric and (ii) a member that is coupled to one of said housings by way of a spring-loaded roller such that slack in said member is taken up.

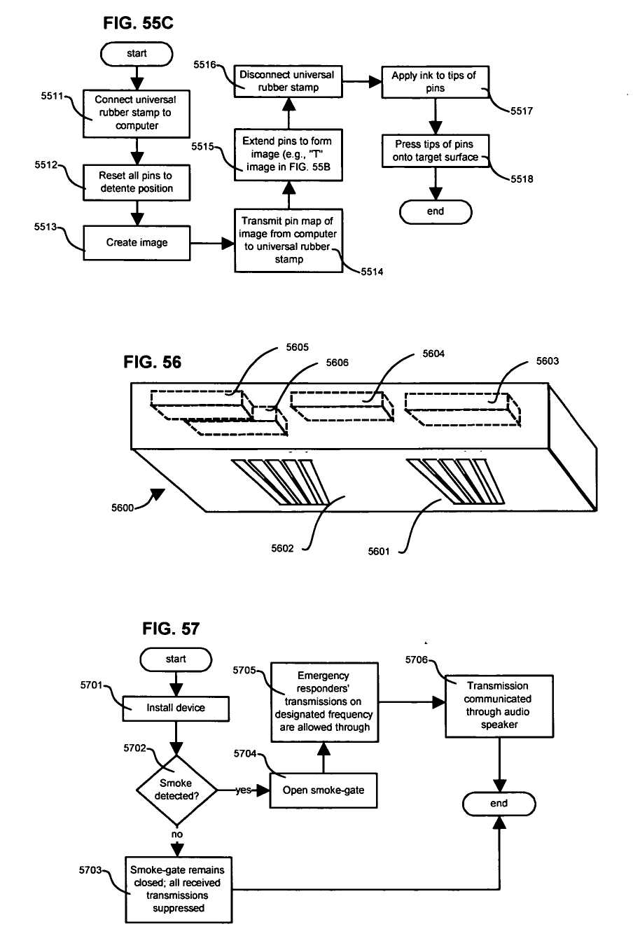

For those EBD users who need to carry a rubber stamp to the above-described meeting, an infinitely configurable, universal rubber stamp system and process are disclosed in FIGS. 55A through 55C. The infinitely configurable rubber stamp 5501 provides a bed of a multitude of rigid, rubber, cylindrical pins 5502 which are each independently and movably mounted on a motor housing 5505. Each pin is configured to extend or contact by function of either (i) a screwing motion or a (ii) gear that interlocks with the base of the pin to move it in or out and hold it in place (not pictured). A port 5504 appears on the motor housing 5505 for data exchange with a computer such as that depicted in FIG. 5. The universal rubber stamp 5501 is connected 5511 to a computer and all pins are reset 5512 to detente position (FIG. 55A). An image is created 5513 on the computer, which image can simply be text characters or an image file (.jpg or .gif, for example) and a “pin map” of the image is transmitted 5514 from the computer to the universal rubber stamp 5501. Pins are extended 5515 to conform to the pin map and thereby form the transmitted image, such as the example depicted in FIG. 55B, in which seven pins have been extended to form an image of a capital letter “T” 5503. The universal rubber stamp 5501 is then disconnected 5516 from the computer, and ink is applied 5517 to the tips of the tens by pressing the universal rubber stamp pin bed 5502, which includes the pins used in the image 5503, into a conventional rubber stamp ink pad (not depicted). The inked tips of the pins are then touched 5518 to a surface (not depicted) to print the image onto the surface. It should be noted that, for simplicity purposes, the depicted example includes only a small number of pins, but that ideally more pins should be used in construction of a universal stamp according to the present invention so that more complex images can be formed. Note also that the invention can be constructed on a very large scale or on a small scale without exceeding the scope of the invention.

The universal rubber stamp may therefore be described generally as follows: a rubber stamp system comprising: a housing; a plurality of moving mechanisms suitable for moving elongated members; a plurality of elongated members independently coupled to said housing and configured to be moved independently by said moving mechanisms into a first position or alternately a second position; an information port in said housing configured to communicatively couple to a computer; a computer; an ink pad suitable for applying ink to a rubber stamp; and an electronic file comprising a map specifying which of said plurality of elongated members are assigned to said first position and which of said plurality of elongated members are assigned to said second position so that said elongated members in said second position collectively form a first image.

EBD users who attend a venue described above will find their peace of mind enhanced if the given venue installs 5701 a disclosed smoke alarm device 5600 such as that depicted in FIG. 56 and used according to the method shown in FIG. 57. The device 5600 provides a housing 5601 configured to allow smoke to pass through vents 5602 so as to be detectable by a smoke detector unit 5603. The device 5600 further provides a data-processing unit 5604 equipped with a radio receiver 5605 in communication with an audio speaker 5606. When smoke is detected 5702, a disclosed “smoke gate” function is triggered 5704. This function is analogous to the function of a conventional “noise gate” used in music technology, except that opening of the gate depends upon detection of smoke, not upon strength of electrical signal. When the smoke gate opens 5704, radio transmissions on a particular frequency used by emergency personnel 5705, which transmissions are normally suppressed 5703 by function of the smoke gate, are allowed to pass through 5704, such that they are instead output 5706 by audio speaker. In this way, emergency personnel can communicate directly to the people who are within earshot of the device 5600. Such an emergency speaker system is particularly useful if there is a situation in which one stairway is blocked but another stairway is still accessible, for instance. In such a case, emergency personnel can tell those experiencing the emergency to make their exit through one staircase as opposed to the other. Yet, by function of the smoke gate, the smoke alarm runs no risk of announcing emergency transmissions that are intended for other locations experiencing other emergencies.

The disclosed smoke alarm system may therefore be described generally as follows: a smoke alarm system comprising: a smoke detecting unit; an audio speaker; a receiver configured to receive radio transmission signals on a predetermined frequency, said frequency being assigned to emergency responder transmissions, and to relay said signals to said speaker; and a data processing unit configured to suppress the relay of said signals from said receiver to said speaker unless smoke is detected by said smoking detecting unit.

Although the description above contains many specificities, these should not be construed as limiting the scope of the invention but as merely providing illustrations of some of the presently preferred embodiments of this invention. Accordingly, the scope of the invention should be determined by the appended claims and their legal equivalents, rather than by the examples given. For instance, as is plain to one skilled in the art, it will be understood that features of one embodiment may be combined with features of other embodiments while other features may be omitted or replaced as being nonessential to the practice of the invention, regardless of whether such combination, omission or modification has been explicitly described. Licensing information may be obtained through http://www.inventerprise.com.

What is claimed is:

1. An apparatus for use in studying, said apparatus comprising:
a base member;
a first indicium, said first indicium pertaining to a first topic, such as a field of law;
a second indicium, said second indicium pertaining to a second topic, said second topic relating to and being more specific than said first topic, such as a first heading within said field of law;
a third indicium, said third indicium pertaining to a third topic, said third topic relating to and being more specific than said first topic, such as a second heading within said field of law;
a fourth indicium, said fourth indicium pertaining to a fourth topic, said fourth topic relating to and being more specific than said second topic, such as a first subheading that falls under said first heading;
a first study module, said first study module comprising a first cover member and a first intermediate member; and
a second study module, said second study module comprising a second cover member and a second intermediate member, wherein:
said first intermediate member is positioned between said first cover member and said base member but not between said second cover member and said base member;
said second intermediate member is positioned between said second cover member and said base member but not between said first cover member and said base member;
said second indicium is affixed to said first cover member;
said third indicium is affixed to said second cover member;
said fourth indicium is affixed to said first intermediate member; and
said first study module and said second study module are disposed upon said base member such that said second indicium and said third indicium can be seen simultaneously.

2. The apparatus in claim 1 wherein said first cover member is movably coupled to said base member.

3. The apparatus in claim 1 wherein said first intermediate member is movably coupled to said base member.

4. The apparatus in claim 2 wherein at least one of said first cover member, said second cover member, and said first intermediate member is pivotably coupled to said base member so as to pivot about a first axis and wherein at least one of said first cover member, said second cover member, and said first intermediate member is pivotably coupled to said base member so as to pivot about a second axis, said second axis being different from said first axis.

5. The apparatus in claim 2 wherein at least one of said first cover member, said second cover member, and said first intermediate member is slidably coupled to said base member so as to be movable linearly.

6. The apparatus in claim 4 wherein at least one of said first cover member, said second cover member, and said first intermediate member is slidably coupled to said base member so as to be movable linearly.

7. The apparatus in claim 4 wherein at least one of said first cover member, said second cover member, and said first intermediate member is pivotably coupled to said base member so as to pivot about a third axis, said third axis being different from said first axis and different from said second axis.

8. The apparatus in claim 7 wherein said second intermediate member is slidably coupled to said base member so as to be movable linearly.

10. The apparatus in claim 1 additionally comprising a third study module, said third study module comprising a third cover member and a third intermediate member, said third intermediate member being positioned between said third cover member and said base member but not between said first cover member and said base member and not between said second cover member and said base member.

11. The apparatus in claim 10 wherein said first study module, said second study module, and said third study module are all of a different predominant color.

12. The apparatus in claim 1 additionally comprising a third intermediate member and a fourth intermediate member, wherein:
said third intermediate member and said fourth intermediate member are positioned between said first cover member and said base member but not between said second cover member and said base member;
said third intermediate member is not positioned between said fourth intermediate member and said base member; and
said fourth intermediate member is not positioned between said third intermediate member and said base member.

13. The apparatus in claim 1 wherein at least a portion of said first intermediate member can be seen through a window in said first cover member.

14. The apparatus in claim 1 wherein said first cover member comprises a front surface and a back surface and said second indicium is affixed to both said front surface and said back surface.

15. The apparatus in claim 10 wherein at least one of said first cover member, said second cover member, said third cover member, said first intermediate member, said second intermediate member, and said third intermediate member rotates about a first line; at least one of these members rotates about a second line; at least one of these members rotates about a third line; at least one of these members moves linearly along a fourth line; and at least one of these members moves linearly along a fifth line, wherein all five of these lines are different lines.

16. The apparatus in claim 12 additionally comprising a fifth intermediate member, said fifth intermediate member being positioned between said third intermediate member and said base member.

17. An apparatus for use in learning, said apparatus comprising:
a base member;
a first indicium indicating a category;
a second indicium indicating a first subcategory within said category;
a third indicium indicating a first sub-subcategory within said first subcategory;
a first movable member, said first movable member being movably coupled to said base member; and
a second movable member, said second movable member being movably coupled to said base member, wherein:
said first movable member is pivotably coupled to said base member so as to rotate about a first line;
said second movable member is selected from the group consisting of (i) a pivotable member that is pivotably coupled so as to rotate about a second line or (ii) a slidable member that is slidably coupled so as to move linearly along said second line;
and said second line is distinct from and nonparallel to said first line.

18. The apparatus in claim 17 wherein:
said first movable member comprises a front surface and a back surface;
said second indicium is printed on both said front surface and said back surface of said first movable member;
said third indicium is printed on said second movable member; and
said first movable member is alternately positionable in a first position, in which position said first movable member covers said second movable member so that said third indicium cannot be seen, and a second position, in which position said first movable member does not cover said second movable member so that said third indicium can be seen.

19. The apparatus in claim 18 additionally comprising a third movable member, said third movable member being selected from the group consisting of (i) a pivotable member that is pivotably coupled so as to rotate about a third line or (ii) a slidable member that is slidably coupled so as to move linearly along said third line, wherein said third line is distinct from and nonparallel to said first line and also distinct from and nonparallel to said second line.

20. A method of learning a first subject said method comprising the following steps:
creating an outline, said outline comprising at least a first main topic within said subject and a second main topic within said subject and at least a first subtopic within said first main topic;
assigning said first subject to a first apparatus, said apparatus comprising a base member and a plurality of movable members movably coupled to said base member;
affixing an indicium of said first main topic on a first movable member;
affixing an indicium of said second main topic on a second movable member;
affixing an indicium of said subtopic on a third movable member;
performing a first movement step, said first movement step further comprising the step of rotating said first movable member about a first line;
performing a second movement step, said second movement step further comprising the step of rotating said second movable member about a second line, said second line being distinct from said first line; and
performing a third movement step, said third movement step further comprising a step selected from the group consisting of (i) the step of rotating said third movable member of about a third line and (ii) the step of sliding said third movable member along a third line, said third line being distinct from said first line and from said second line.
